(19) United States
(12) Patent Application Publication
(10) Pub. No.: US 2024/0408622 A1
(43) Pub. Date: Dec. 12, 2024

(54) SPRAY DEVICES FOR DISPENSING FLUID AND METHODS OF MANUFACTURING

(71) Applicant: United Industries Corporation, Earth City, MO (US)

(72) Inventor: Alex J. Wall, St. Louis, MO (US)

(21) Appl. No.: 18/692,889

(22) PCT Filed: Sep. 28, 2022
(86) PCT No.: PCT/US2022/077157

§ 371 Date: Mar. 18, 2024

Related U.S. Application Data
(60) Provisional application No. 63/250,590, filed on Sep. 30, 2021.
(60) Provisional application No. 63/250,608, filed on Sep. 30, 2021.

(51) Int. Cl. B05B 1/16; B05B 9/08; B05B 12/00

(52) U.S. Cl. CPC B05B 1/1645; B05B 9/0861; B05B 12/0026

(57) ABSTRACT

A spray device for dispensing fluid includes a container having a container body and a sprayer assembly. The sprayer assembly includes a housing coupled to the container, a nozzle assembly rotatably supported on the housing and having at least a first nozzle and a second nozzle. The first nozzle discrete and separated from the second nozzle on the nozzle assembly. The sprayer assembly also includes an actuator supported by the housing and coupled in fluid communication with the nozzle assembly. The spray device may also include a wand assembly including a wand body having a reservoir configured to hold a charge of the fluid to be dispensed, a nozzle, an actuator configured to selectively dispense fluid from the wand assembly via the nozzle, and a hose connector releasably couplable to the wand body.

### CROSS-REFERENCE TO RELATED APPLICATIONS

This application is being filed on Sep. 28, 2022, as a PCT International Patent Application that claims priority to and the benefit of U.S. Provisional Application No. 63/250,590, filed on Sep. 30, 2021, and U.S. Provisional Application No. 63/250,608, filed on Sep. 30, 2021, the disclosures of which are hereby incorporated by reference herein in their entirety.

### BACKGROUND

The present disclosure relates generally to spray devices for dispensing fluid and methods of manufacturing spray devices for pesticides, herbicides, fungicides, and the like.

At least some known spray devices have a container with a flipable wand. The flipable wand can enable a more precise positioning of the nozzle relative to the area to be treated. Additionally, the movement of the flipable wand can perform a locking function for fluid discharge from the nozzle. For example, when the wand is extended, a user can discharge fluid from the spray device, while when the wand is retracted, the user is prevented from discharging fluid. However, these flipable wands only include one nozzle for fluid discharge. Improvements to spray devices are thereby desired.

Additionally, some known spray devices have a container with a hand-held spray gun. The hand-held spray gun is attached to the container with a flexible hose so that the spray gun can move relative to the container and be positioned as required or desired for use. However, with the hand-held spray gun being permanently attached to the container during use, the entire spray device including the container must be moved by the user. Improvements to spray devices are thereby desired.

### Spray Devices for Dispensing Fluid and Methods of Manufacturing

In one aspect, the technology relates to a spray device for dispensing fluid, the spray device including: a container including a container body configured to hold the fluid to be dispensed; and a sprayer assembly including: a housing coupled to the container; a nozzle assembly rotatably supported on the housing and having at least a first nozzle and a second nozzle, the first nozzle discrete and separated from the second nozzle on the nozzle assembly; and an actuator supported by the housing and coupled in fluid communication with the nozzle assembly, the actuator configured to selectively dispense fluid from the sprayer assembly via the nozzle assembly, wherein the nozzle assembly is rotatable between at least two spray configurations, a first spray configuration whereby the actuator dispenses fluid from the first nozzle and a second spray configuration whereby the actuator dispenses fluid from the second nozzle.

In an example, the nozzle assembly is rotatable around a rotation axis, the first nozzle being oblique relative to the rotation axis. In another example, the second nozzle is oblique relative to the rotation axis. In yet another example, the second spray configuration is a 180° rotation from the first spray configuration. In still another example, the first nozzle is oriented in an orthogonal direction relative to the second nozzle. In an example, the nozzle assembly includes an extender, the second nozzle disposed on a distal end of the extender.

In another example, the nozzle assembly is rotatable around a rotation axis, the nozzle assembly rotatable in both directions around the rotation axis. In yet another example, the nozzle assembly includes a stop indent for registering the nozzle assembly in both the first and second spray configurations. In still another example, the stop indent provides an audible and/or a tactile register when the nozzle assembly is moved into the first and second spray configurations. In an example, the actuator includes a lock to prevent accidental fluid dispense. In another example, the housing is removably coupled to the container body.

In yet another example, the housing is connected to the container body with a threaded connection, a rotating connection, a bayonet connection, or a press connection. In still another example, the container body includes a fill level view strip. In an example, the actuator of the sprayer assembly is battery powered. In another example, the first nozzle and the second nozzle have different discharge configurations.

In another aspect, the technology relates to a method of manufacturing a spray device for dispensing fluid, the method including: forming a container having a container body configured to hold the fluid to be dispensed; assembling a sprayer assembly having a housing rotatably supporting a nozzle assembly and supporting an actuator, wherein the nozzle assembly has at least a first nozzle and a second nozzle, the first nozzle discrete and separated from the first nozzle on the nozzle assembly, and wherein the nozzle assembly is rotatable between at least two spray configurations; and coupling the sprayer assembly to the container, wherein the actuator is configured to selectively dispense fluid from the sprayer assembly via the nozzle assembly such that in a first spray configuration, the actuator dispenses fluid from the first nozzle, and in a second spray configuration, the actuator dispenses fluid from the second nozzle.

In an example, the method further includes filling the container body with fluid. In another example, the fluid is one or more of a pesticide, an herbicide, or a fungicide. In yet another example, assembling the sprayer assembly includes forming the nozzle assembly with the first nozzle oriented in an orthogonal direction relative to the second nozzle. In still another example, coupling the sprayer assembly to the container includes removably connecting the housing to the container body with a threaded connection, a rotating connection, a bayonet connection, or a press connection.

In another aspect, the technology relates to a spray device for dispensing fluid, the spray device including: a container including a container body configured to hold the fluid to be dispensed; and a sprayer assembly including: a nozzle assembly rotatably supported on the container around a rotation axis and having at least a first nozzle and a second nozzle, the first nozzle discrete and separated from the second nozzle on the nozzle assembly, wherein the first nozzle and the second nozzle are oblique relative to the rotation axis; and an actuator supported by the container body and coupled in fluid communication with the nozzle assembly, the actuator configured to selectively dispense fluid from the sprayer assembly via the nozzle assembly, wherein the nozzle assembly is rotatable between at least two spray configurations, a first spray configuration whereby the actuator dispenses fluid from the first nozzle and a second spray configuration whereby the actuator dispenses fluid from the second nozzle.

Additionally, in one aspect, the technology relates to a spray device for dispensing fluid, the spray device including: a container including a container body configured to hold the fluid to be dispensed; a wand assembly including: a wand body having a reservoir configured to hold a charge of the fluid to be dispensed; a nozzle; an actuator configured to selectively dispense fluid from the wand assembly via the nozzle; and a hose connector releasably couplable to the wand body; a hose extending between the container body and the hose connector, and coupling the wand assembly in fluid communication to the container; and a mount releasably coupling the wand body to the container body, wherein when the wand body is engaged with the hose connector, the wand assembly is configured to dispense fluid while being connected to the container via the hose, and when the wand body is disengaged from the hose connector, the wand assembly is configured to dispense fluid from the reservoir while the wand body is disconnected from the container and completely remote therefrom.

In an example, the actuator includes a lock to prevent accidental fluid dispense. In another example, the nozzle is mounted on an extender. In yet another example, the mount is coupled to the container body. In still another example, the mount is integral with the container body. In an example, the spray device further includes a hose wrap configured to store at least a portion of the hose in a wrapped configuration.

In another example, the hose wrap is interconnected with the mount. In yet another example, the wand body includes a window into the reservoir. In still another example, the actuator of the wand assembly is battery powered. In an example, the wand body is detachable from the hose connector via a button. In another example, the reservoir has a smaller volume than the container body.

In yet another example, when the wand body is engaged with the hose connector, the fluid dispensed from the wand assembly flows through the reservoir. In still another example, after the wand assembly is used remote from the container, the wand assembly is configured to automatically refill the charge of fluid within the reservoir. In an example, the spray device further includes a cap having a dip tube for the container, the cap configured to receive the hose. In another example, the nozzle has two or more different discharge configurations.

In another aspect, the technology relates to a method of manufacturing a spray device for dispensing fluid, the method including: forming a container having a container body configured to hold the fluid to be dispensed; assembling a wand assembly that includes a wand body with a reservoir configured to hold a charge of the fluid to be dispensed, a nozzle, an actuator configured to selectively dispense fluid from the wand assembly via the nozzle, and a hose connector that releasably couples to the wand body; providing a hose that couples the wand assembly to the container in fluid communication; forming a mount; and releasably coupling the wand body to the container body via the mount, and wherein when the wand body is engaged with the hose connector, the wand assembly is configured to dispense fluid while being connected to the container via the hose, and when the wand body is disengaged from the hose connector, the wand assembly is configured to dispense fluid from the reservoir while the wand body is disconnected from the container and completely remote therefrom.

In an example, the method further includes filling the container body with fluid. In another example, the fluid is one or more of a pesticide, a herbicide, and a fungicide. In yet another example, the method further includes wrapping at least a portion of the hose around a hose wrap. In still another example, the wand body is formed with a battery chamber such that the wand assembly is battery powered.

### BRIEF DESCRIPTION OF THE DRAWINGS

FIG. 1 a perspective view of an exemplary spray device.

FIG. 2 is a side elevation view of the spray device shown in FIG. 1.

FIG. 3 is an exploded perspective view of the spray device shown in FIG. 1

FIG. 4 is a perspective view of another spray device.

FIGS. 5-7 are a side elevation views of the spray device shown in FIG. 4.

FIG. 8 is a perspective view of another spray device in a first spray configuration.

FIG. 9 is another perspective view of the spray device shown in FIG. 8.

FIG. 10 is a perspective view of the spray device shown in FIG. 8 in a second spray configuration.

FIG. 11 is another perspective view of the spray device shown in FIG. 10.

FIGS. 12-15 are side elevation views of the spray device shown in FIGS. 8 and 9 in the first spray configuration.

FIG. 16 is a top view of the spray device shown in FIGS. 8 and 9 in the first spray configuration.

FIG. 17 is a bottom view of the spray device shown in FIGS. 8 and 9 in the first spray configuration.

FIGS. 18-21 are side elevation views of the spray device shown in FIGS. 10 and 11 in the second spray configuration.

FIG. 22 is a top view of the spray device shown in FIGS. 10 and 11 in the second spray configuration.

FIG. 23 is a bottom view of the spray device shown in FIGS. 10 and 11 in the second spray configuration.

FIG. 24 is a partial exploded perspective view of the spray device shown in FIG. 8.

FIG. 25 is a cross-sectional schematic view of the spray device shown in FIG. 8.

FIG. 26 illustrates a flowchart illustrating a method of manufacturing a spray device for dispensing fluid.

FIG. 27 a perspective view of another exemplary spray device.

FIG. 28 is a side elevation view of the spray device shown in FIG. 27.

FIG. 29 is another side elevation view of the spray device shown in FIG. 27

FIG. 30 is a partial exploded perspective view of the spray device shown in FIGS. 27-29.

FIG. 31 is a side elevation view of the spray device shown in FIG. 30.

FIG. 32 is a partial perspective view of the spray device shown in FIG. 30.

FIG. 33 is a perspective view of another spray device.

FIG. 34 is another perspective view of the spray device shown in FIG. 33.

FIG. 35 is an exploded perspective view of the spray device shown in FIGS. 33 and 34.

FIGS. 36-39 are side elevation views of the spray device shown in FIGS. 33-35.

FIG. 40 is a top view of the spray device shown in FIGS. 33-35.

FIG. 41 is a bottom view of the spray device shown in FIGS. 33-35.

FIG. 42 is a cross-sectional schematic view of the spray device shown in FIGS. 33-35.

FIG. 43 illustrates a flowchart illustrating a method of manufacturing a spray device for dispensing fluid.

### DETAILED DESCRIPTION

The technologies described herein relate to a spray device having a rotatable sprayer tip so that different spray patterns can be switched between. For example, the different spray patterns may be spray and stream, or any other pattern as required or desired. The sprayer tip has two different nozzles and can rotate in either direction so as to change between nozzles and spray patterns. The spray devices can be formed from a container and a sprayer assembly being aesthetically and ergonomically integrated together. The sprayer assembly may be useable with replacement containers. In aspects, the sprayer assembly may be battery powered. The sprayer assembly may have a lock feature to reduce or prevent accidental trigger activation.

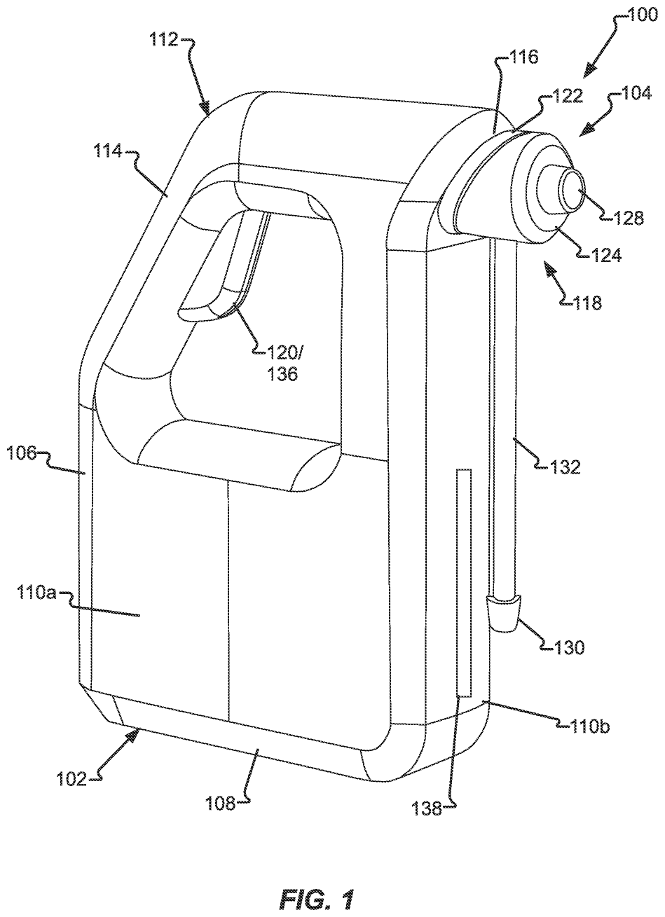

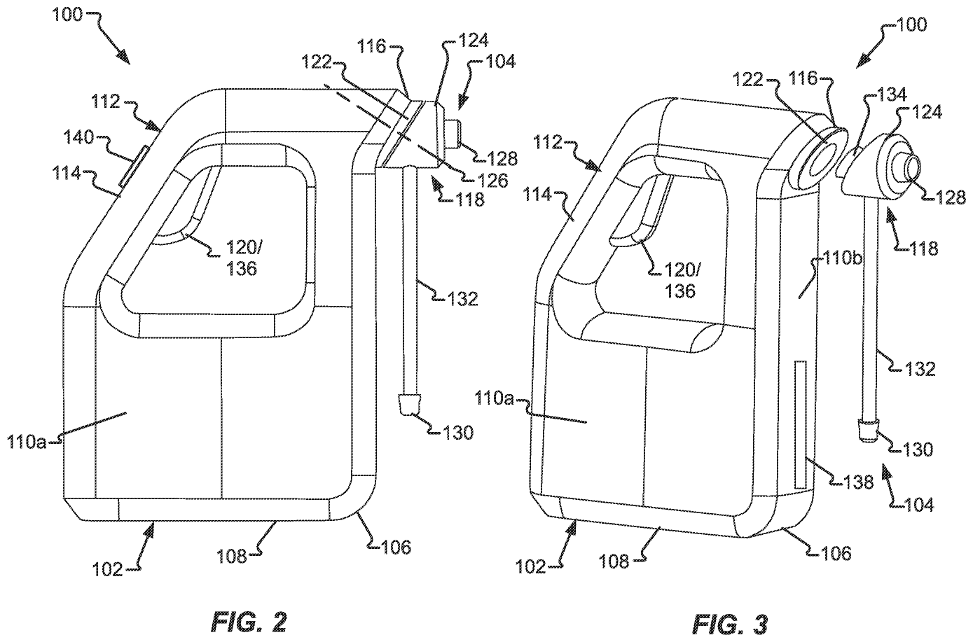

FIG. 1 a perspective view of an exemplary spray device 100. FIG. 2 is a side elevation view of the spray device 100. FIG. 3 is an exploded perspective view of the spray device 100. Referring concurrently to FIGS. 1-3, the spray device 100 is configured to retain and selectively dispense fluid therefrom. In examples, the fluid may be a formulation such as a pesticide, a herbicide, a fungicide, or the like and a user utilizes the spray device 100 as a treatment for indoor or outdoor areas. For example, the fluid may be an insecticide (e.g., a type of pesticide) for an indoor or outdoor foundation treatment to kill and/or control insects. In another example, the fluid may be a herbicide or a fungicide for outdoor lawn or plant area treatment to kill and/or control weeds, diseases, fugus, or the like. It should be appreciated, that the spray device 100 described herein can be used with any other type of fluid as required or desired. For example, the fluid can be, but is not limited to, a cleaner solution, a stain remover, water, etc. In an aspect, the fluid can be a floor cleaner, a kitchen or bath cleaner, leather or fabric cleaner, outdoor cleaner, a sanitizer or disinfectant, and the like. The spray device 100 is configured to discharge fluids that are both viscous and emulsions.

In the example, the spray device 100 includes a container 102 and a sprayer assembly 104. The container 102 includes a container body 106 forming a hollow interior configured to hold the fluid to be dispensed. The container body 106 may be formed from a plastic-based material according to known molding processes, and shaped and sized to hold between 16-128 ounces of fluid or more. In an aspect, the container 102 may be pre-filled with fluid so that the user may purchase the container 102 in a substantially usable condition without needing to mix, fill, or stir the fluid contained therein.

The container body 106 has a bottom wall 108 so that the spray device 100 can stand up-right on its own and one or more sidewalls 110 that at least partially define the shape of the container 102. In the example, the sidewalls 110 have a substantially rectangular shape with a pair of opposing major sidewalls 110a and a pair of opposing minor sidewalls 110b. The major sidewalls 110a may be used for product labeling, while components of the sprayer assembly 104 may be disposed proximate the minor sidewalls 110b. In other examples, the minor sidewalls 110b may be used for product labeling, while components of the sprayer assembly 104 may be disposed proximate the major sidewalls 110a.

Opposite the bottom wall 108, the container body 106 has a top portion 112. The top portion 112 may form a handle 114 that accommodates a grip of the user's hand. As such, the spray device 100 can be considered a hand-held sprayer having an appropriate size and weight for handling by the user without undue strain and without external assistance in the form of a carriage or other supporting means. Alternatively, it is to be understood that the handle 114 may be omitted and the spray device 100 can still be considered a hand-held sprayer. Additionally, the top portion 112 also forms a neck 116 having opening that enables the fluid to be received by, and extracted from within, the container body 106. In the example, the neck 116 is substantially cylindrical and configured to receive a portion of the sprayer assembly 104.

The sprayer assembly 104 includes a nozzle assembly 118 that is rotatably supported on the container body 106 of the container 102 and an actuator 120 supported by the container body 106. The nozzle assembly 118 includes a collar 122 configured to fix to the container body 106 at the neck 116. A dip tube (not shown) is coupled to the collar 122 and extends into the interior of the container body 106 towards the bottom wall 108. The nozzle assembly 118 also includes a nozzle manifold 124 that is rotatably connected to the collar 122 and establishes fluid communication with the dip tube. As such, the sprayer assembly 104 is in fluid communication with the container 102 and configured to discharge the fluid from the spray device 100.

In the example, the nozzle manifold 124 is rotatable around a rotation axis 126 (shown in FIG. 2) and relative to the collar 122 and container 102. The collar 122 and the nozzle manifold 124 each have planar oblique surfaces that enable rotation of the nozzle manifold 124 around the rotation axis 126. In an aspect, these surfaces are at a 45° angle relative to horizontal and vertical directions of the spray device 100 as it is in an up-right position. The rotation axis 126 is substantially orthogonal to planar oblique surfaces, and thus, the rotation axis 126 is also at a 45° angle relative to horizontal and vertical directions. The nozzle manifold 124 includes at least a first nozzle 128 and a second nozzle 130. The second nozzle 130 is disposed on a distal end of an elongated extender 132 that extends from the nozzle manifold 124. The first nozzle 128 is disposed directly on the nozzle manifold 124. In contrast, the second nozzle 130 is remote from the nozzle manifold 124, and as such, the first nozzle 128 is discrete and separated from the second nozzle 130 on the nozzle manifold 124. The first nozzle 128 is oriented in an orthogonal direction relative to the second nozzle 130. The actuator 120 is configured to selectively dispense fluid from either the first nozzle 128 or the second nozzle 130 when actuated by the user. In the example, the rotational position of the nozzle assembly 118 determines which nozzle 128, 130 discharges the fluid.

In operation, the nozzle assembly 118 is rotatable between at least two spray configurations. For example, a first spray configuration is illustrated in FIGS. 1-3 whereby the second nozzle 130 and the extender 132 are disposed adjacent to the minor sidewall 110b and in a downward direction so that the actuator 120 dispenses fluid from the first nozzle 128. In this configuration, the rotational position of the nozzle manifold 124 creates a flow circuit from the interior of the container 102 and out of the first nozzle 128. In aspects, this configuration of the spray device 100 may be suitable for treating large surface areas because the first nozzle 128 is shaped and sized for a larger spray pattern.

For a smaller spray pattern and more precise spraying, a second spray configuration (not shown) can be used, whereby the first nozzle 128 is disposed adjacent to the minor sidewall 110b and in a downward direction so that the actuator 120 dispenses fluid from the second nozzle 130. In this configuration, the rotational position of the nozzle manifold 124 creates a flow circuit from the interior of the container 102 and out of the second nozzle 130. In aspects, this configuration of the spray device 100 may be suitable for treating smaller surface areas because the second nozzle 130 is shaped and sized for a smaller spray pattern. Additionally, the second nozzle 130 is in an extended position relative to the container 102 via the extender 132.

In the example, the second spray configuration may be about a 180° rotation of the nozzle assembly 118 from the first spray configuration around the rotation axis 126. In an aspect, the nozzle assembly 118 may rotate towards the second spray configuration in either direction around the rotation axis 126. As such, the nozzle assembly 118 may be rotatable up to 360° around the rotation axis 126. While two different spray configurations are being described herein, it should be appreciated that more than two spray configuration may be used as required or desired. For example, 3 or 4 different spray configurations may be utilized with the nozzle assembly 118 being stopped at lesser degree increments depending on the number of spray configurations.

Between the different spray configurations, the orientation of the nozzles 128, 130 relative to the container body 106 changes and the engaged nozzle 128, 130 is positioned in a substantially horizontal orientation and away from the spray device 100. The orientation of the nozzles 128, 130 between different spray configurations can be measured as a rotational angle relative to the rotation axis 126. The collar 122 and the nozzle manifold 124 each have planar oblique surfaces that enable rotation of the nozzle manifold 124 around the rotation axis 126. The nozzle manifold 124 can include a post 134 that extends opposite of the first nozzle 128 and so that the nozzle manifold 124 can couple in flow communication to the container 102. By being able to operate the sprayer assembly 104 in different spray configurations by merely rotating the nozzle assembly 118, the user can more easily change the discharge configuration of the fluid without needing any additional components or time consuming reconfigurations of the spray device 100.

In the example, the first spray configuration and the use of the first nozzle 128 and the second spray configuration and the use of the second nozzle 130 both draw from the fluid that is contained within the container body 106. As such, only a single fluid circuit is needed by the sprayer assembly 104 with the nozzle manifold 124 configured to selectively block fluid flow to the non-engaged nozzle 128, 130 depending on the rotational position of the manifold 124. By using two separate nozzles 128, 130, the discharge spray characteristics of the fluid can be specifically tailored for each nozzle as required or desired.

The actuator 120 includes a spring loaded trigger element 136 that is pivotably mounted to the container body 106. The trigger element 136 is coupled in communication with a battery powered pump mechanism (not shown) disposed within the container body 106 and is in fluid communication with the nozzle assembly 118 so that fluid can be pumped through the sprayer assembly 104 and discharged at the nozzle 128 or 130. In an aspect, the pump mechanism may be disposed in the top portion 112 and proximate the handle 114. In operation, the user can squeeze the trigger element 136 to energize the pump mechanism and pump fluid from the container 102, through the nozzle assembly 118, and to the nozzle 128 or 130 wherein the fluid is discharged from the spray device 100. Continuous spraying of fluid may be accomplished without repetitive actuation of the trigger element 136 by holding the trigger element 136 in an activated position (e.g., depressed). When the trigger element 136 is released, the trigger element returns to a deactivated position and deenergizing the pump mechanism. In this example, the sprayer assembly 104 also include a battery chamber (not show) that allows the user to replace the batteries as required or desired.

In other aspects, the sprayer assembly 104 may not be battery operated. Rather, the trigger element 136 is coupled in communication with a mechanical pump mechanism disposed within the container body 106. In this example, the user must use the trigger element 136 as a pump lever and so as to create fluid pressure in order to discharge the fluid from the nozzle 128 or 130. As such, every squeeze of the trigger element 136 may generate a discharge spray of fluid.

One or both of nozzles 128, 130 may be a rotatable nozzle (e.g., rotatable relative to the manifold 124/extender 132) so that the manner of discharge of the fluid flowing through the nozzle assembly 118 can further be adjusted. In an aspect, rotation of the nozzle 128, 130 may change the discharge between at least a conical stream configuration and a fanned spray configuration. As such, the nozzles 128, 130 can have two or more different discharge configurations, for example, a spray, a stream, a fan, a cone, etc. In other aspects, a conical spray configuration may be used. Additionally or alternatively, the nozzles 128, 130 may have other features as required or desired. In the example, the first nozzle 128 has a different discharge configuration than the second nozzle 130. In other examples, both the first nozzle 128 and the second nozzle 130 may be substantially similar. In an aspect, the nozzles 128, 130 are shaped and sized to discharge fluids having viscosity up to 800 centipoise and discharge an average spray particle size of between 20 to 200 microns.

In the example, the top portion 112 of the container body 106 and the handle 114 is integrally formed such that the entire container body 106 is a single molded component piece. The sprayer assembly 104 is supported by the container body 106 and is configured to enable the discharge of the fluid within the container body 106. In other examples, the sprayer assembly 104 may be a component with its own housing that is attachable to the container body 106. By enabling the sprayer assembly 104 to detach from the container body 106, the spray device 100 can have the sprayer assembly 104 be reusable and transferable to replaceable containers 102 so that replacement containers 102 are economically more efficient.

The container body 106 may also include a fill level view strip 138 so that the user can see the fill volume of the container 102. The view strip 138 may also provide a way for the user to know/see if the sprayer assembly 104 is primed. In an aspect, the view strip 138 may be located on one of the minor sidewalls 110b. The actuator 120 may also include a lock 140 for the trigger element 136 so that the trigger can be locked out from being accidentally pressed and to prevent accidental fluid dispense.

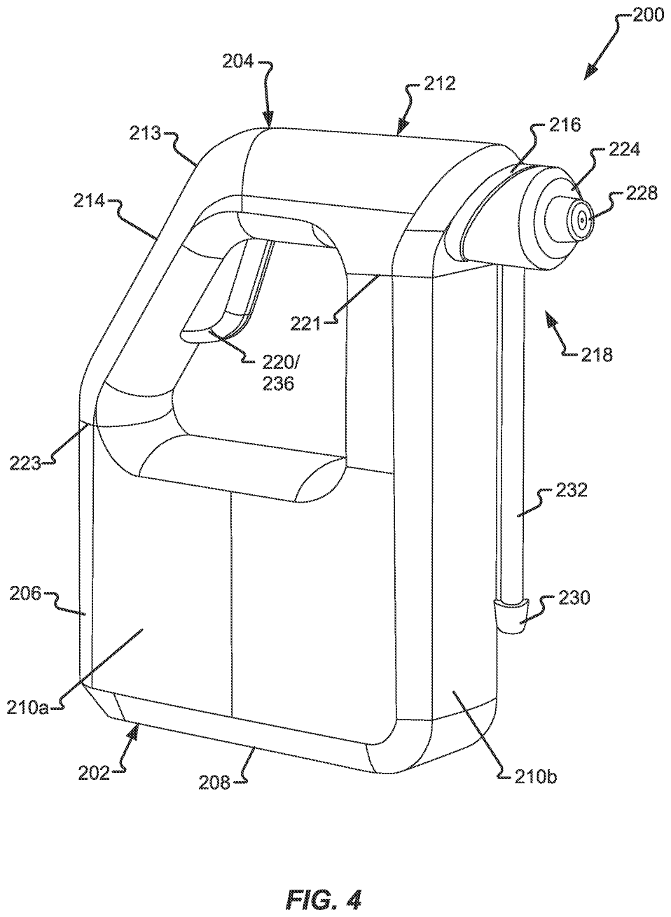

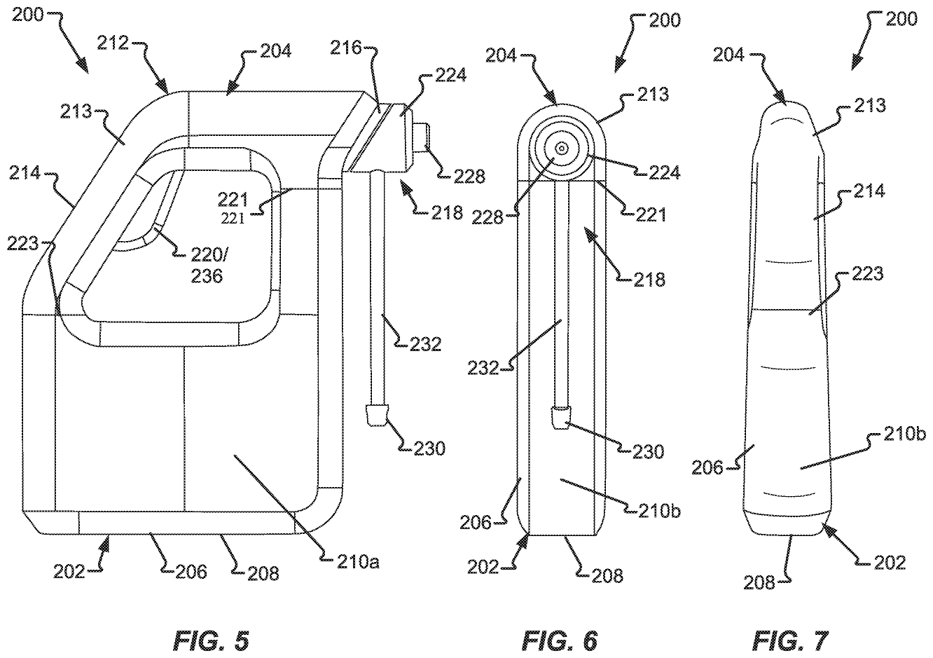

FIG. 4 is a perspective view of another spray device 200. FIGS. 5-7 are a side elevation views of the spray device 200. Referring concurrently to FIGS. 4-7, the spray device 200 is similar to the spray device described above and is configured to retain and selectively dispense fluid therefrom. The spray device 200 includes a container 202 and a sprayer assembly 204. The container 202 has a container body 206 configured to hold the fluid to be dispensed. The container body 206 has a bottom wall 208 so that the spray device 200 can stand up-right on its own and a pair of opposing major and minor sidewalls 210a, 210b. The sprayer assembly 204 is in fluid communication with the container 202 and configured to discharge the fluid from the spray device 200.

In this example, a top portion 212 of the spray device 200 is formed by the sprayer assembly 204 having a housing 213 that forms a handle 214 for the spray device 200. The housing 213 forms a neck 216 that rotatably supports a nozzle assembly 218 of the sprayer assembly 204. Additionally, the housing 213 supports an actuator 220 of the sprayer assembly 204 that is coupled in fluid communication with the nozzle assembly 218 and is configured to selectively dispense fluid from the sprayer assembly 204 via the nozzle assembly 218. The sprayer assembly 204 is coupled to the container 202 so as to form the spray device 200. Additionally, the sprayer assembly 204 and the container 202 are shaped and sized to be aesthetically pleasing and ergonomically integrated together.

The housing 213 can be removably coupled to the container body 206 so that the sprayer assembly 204 is reusable and transferable to replaceable containers 202 as required or desired. In an example, the housing 213 may be coupled to the container body 206 at a first mating plane 221. At the first mating plane 221 the dip tube may extend into the container body 206 so that fluid can be dispensed from the nozzle assembly 218. The housing 213 may be connected to the container body 206 by a threaded connection, a rotating connection (e.g., a ¼-turn or reduced rotating coupling feature), a bayonet connection, or a press connection as required or desired. Other connection types that enable the sprayer assembly 204 to function as described herein may alternatively be used.

A second mating plane 223 may be formed on the opposite side of the handle 214. In an example, the second mating plane 223 may not have any components that extend between the sprayer assembly 204 and the container 202, and the housing 213 and the container body 206 are enclosed at this location. In this example, the housing 213 can be more easily rotated to form the connection with the container body 206. In an aspect, at least a portion of the housing 213 may engage with the container body 206 so that the position of the sprayer assembly 204 is more secure with respect to the container 202. As such, the housing 213 can be more easily press fit into place with the container body 206. In another aspect, the second mating plane 223 of the housing 213 may be the access location for the battery chamber of the sprayer assembly 204. In other examples, the housing 213 and the container body 206 may be open to one another at the second mating plane 223 and allow components and/or fluid to pass therebetween.

The nozzle assembly 218 includes a nozzle manifold 224 that is rotatably connected to the neck 216 and establishes fluid communication with the dip tube. In this example, the collar that rotatably supports the nozzle assembly may be formed by the neck 216. The nozzle manifold 224 is rotatable around a rotation axis and relative to the housing 213 and container 202. The nozzle manifold 224 includes at least a first nozzle 228 and a second nozzle 230. The second nozzle 230 is disposed on a distal end of an elongated extender 232 that extends from the nozzle manifold 224. Similar to the example described above, the rotational position of the nozzle assembly 218 determines which nozzle 228, 230 discharges the fluid upon actuation of the actuator 220.

The actuator 220 includes a spring loaded trigger element 236 that is pivotably mounted to the housing 213. The trigger element 236 is coupled in communication with a battery powered pump mechanism (not shown) disposed within the housing 213 and is in fluid communication with the nozzle assembly 218 so that fluid can be pumped through the sprayer assembly 204 and discharged at the nozzle 228 or 230. In an aspect, the pump mechanism may be disposed in the housing 213 and the housing 213 can also include a battery chamber (not shown) that allows the user to replace the batteries as required or desired. In other aspects, the sprayer assembly 204 may not be battery operated. Rather, the trigger element 236 is coupled in communication with a mechanical pump mechanism disposed within the housing 213.

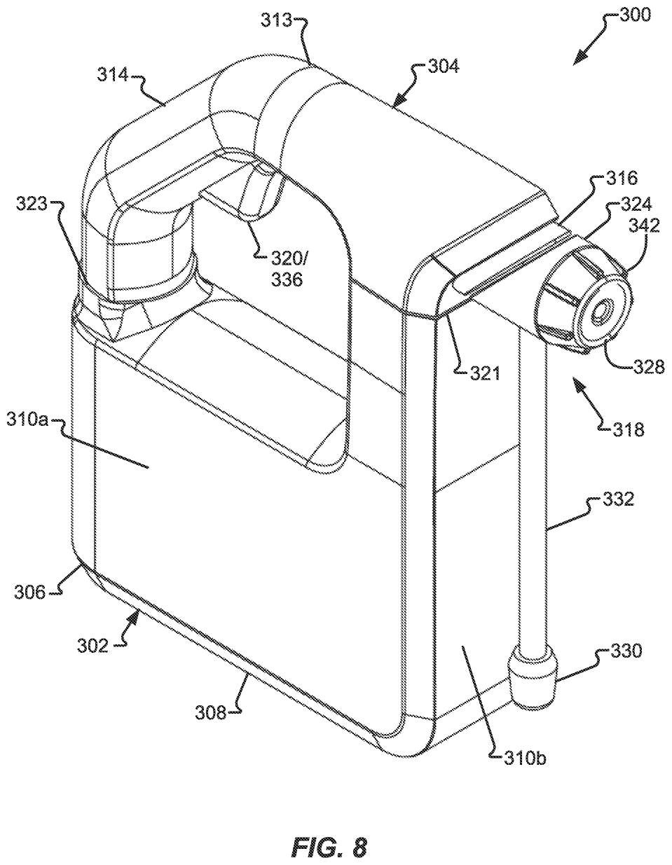

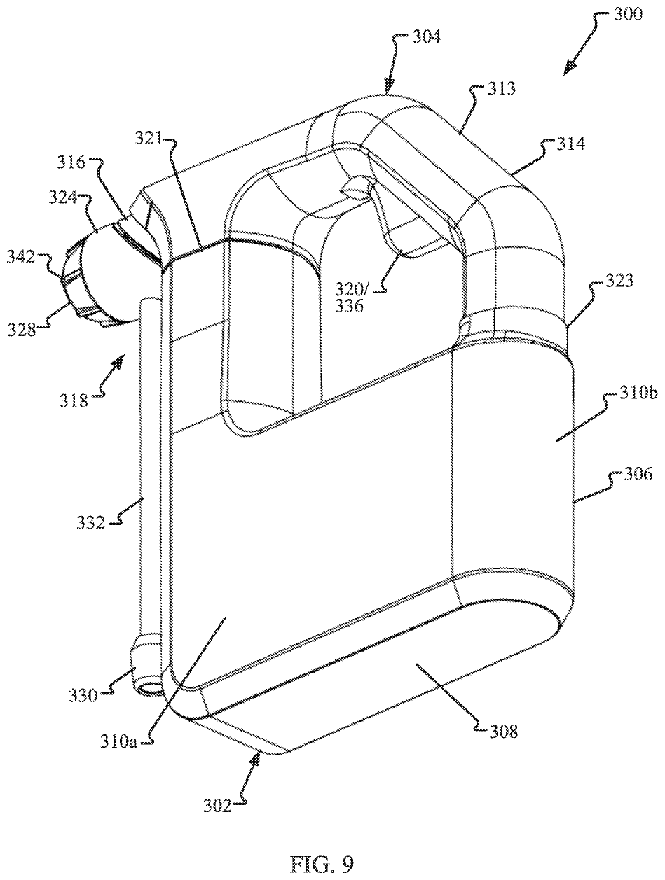

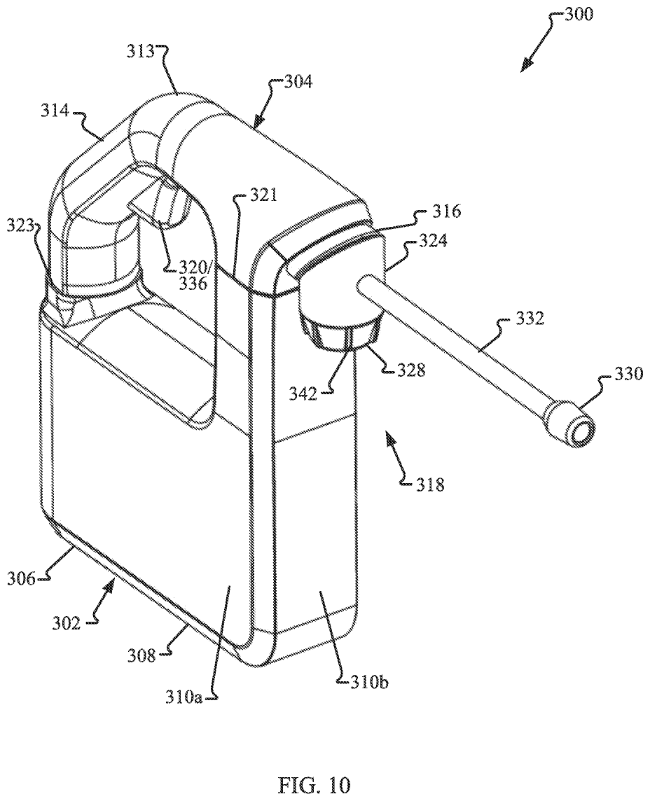

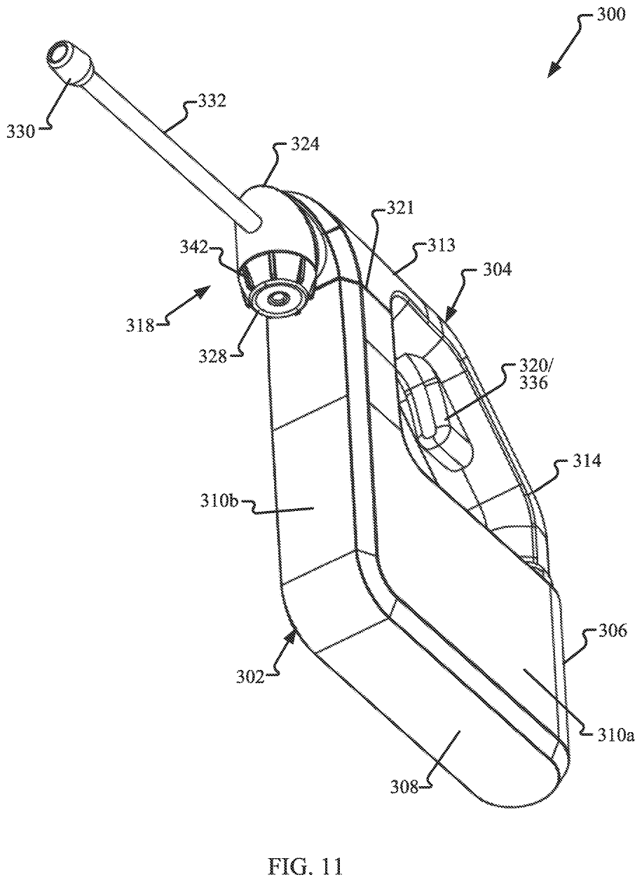

FIG. 8 is a perspective view of another spray device 300 in a first spray configuration. FIG. 9 is another perspective view of the spray device 300 in the first spray configuration. FIG. 10 is a perspective view of the spray device 300 in a second spray configuration. FIG. 11 is another perspective view of the spray device 300 in the second spray configuration. Referring concurrently to FIGS. 8-11, the spray device 300 is similar to the spray devices described above and is configured to retain and selectively dispense fluid therefrom. The spray device 300 includes a container 302 and a sprayer assembly 304. The container 302 has a container body 306 configured to hold the fluid to be dispensed. The container body 306 has a bottom wall 308 so that the spray device 300 can stand up-right on its own and a pair of opposing major and minor sidewalls 310a, 310b. The sprayer assembly 304 is in fluid communication with the container 302 and configured to discharge the fluid from the spray device 300.

In this example, the sprayer assembly 304 has a housing 313 that forms a handle 314 for the spray device 300. The housing 313 rotatably supports a nozzle assembly 318 and supports an actuator 320 to selectively dispense fluid from the sprayer assembly 304. The sprayer assembly 304 is coupled to the container 302 so as to form the spray device 300. In an aspect, the housing 313 is removably coupled to the container body 306 at a first mating plane 321 and a second mating plane 323.

The nozzle assembly 318 includes a nozzle manifold 324 that is rotatably connected to a neck 316 and establishes fluid communication with the dip tube. In this example, the collar that rotatably supports the nozzle assembly 318 may be formed by the neck 316. The nozzle manifold 324 is rotatable around a rotation axis and relative to the housing 313 and container 302. The nozzle manifold 324 includes at least a first nozzle 328 and a second nozzle 330. The second nozzle 330 is disposed on a distal end of an elongated extender 332 that extends from the nozzle manifold 324. Similar to the example described above, the rotational position of the nozzle assembly 318 determines which nozzle 328, 330 discharges the fluid upon actuation of the actuator 320. Additionally, the actuator 320 includes a spring loaded trigger element 336 that is pivotably mounted to the housing 313.

The first spray configuration is illustrated in FIGS. 8 and 9, and in the first spray configuration, the first nozzle 328 is co-axial with a horizontal axis (e.g., substantially parallel to the bottom wall 308), while the second nozzle 330 is co-axial with a vertical axis (e.g., substantially parallel to the sidewalls 310). The first nozzle 328 is configured by the nozzle manifold 324 so as to channel fluid out of the first nozzle 328 while blocking fluid flow to the second nozzle 330. As such, when the user squeezes the trigger element 336 fluid is discharged from the first nozzle 328. In the first spray configuration, the second nozzle 330 and the extender 332 are disposed adjacent the minor sidewall 310b, while the first nozzle 328 is oriented in an outward direction from the spray device 300. In an aspect, the first nozzle 328 defines the discharge spray configuration in the first spray configuration. In other aspects, the first nozzle 328 may be adjustable in the first spray configuration so as to change between at least two different discharge spray configurations.

In operation, the user can rotate the nozzle assembly 318 around its rotation axis to move the spray device 300 from the first spray configuration towards the second spray configuration as illustrated in FIGS. 10 and 11. In the example, the nozzle manifold 324 can include one or more exterior ribs 342 so that the user can more easily grip and turn the nozzle assembly 318. In an aspect, the user can move the spray device 100 between different spray configurations with one hand. In the second spray configuration, the second nozzle 330 is co-axial with the horizontal axis, while the first nozzle 328 is co-axial with a vertical axis. The second nozzle 330 is configured by the nozzle manifold 324 so as to channel fluid out of the second nozzle 330 while blocking fluid flow to the first nozzle 328. In the second spray configuration, the first nozzle 328 is disposed adjacent the minor sidewall 310b, while the second nozzle 330 is oriented in an outward direction and extended from the spray device 300. In an aspect, the second nozzle 330 defines the discharge spray configuration in the second spray configuration. In other aspects, the second nozzle 330 may be adjustable in the second spray configuration so as to change between at least two different discharge spray configurations. In the second spray configuration, the second nozzle 330 is similarly oriented (e.g., horizontally) to the first nozzle 328 when in the first spray configuration, however, the second nozzle 330 is positioned further away from the container 302 when compared to the first nozzle 328 in the first spray configuration. As such, the second spray configuration corresponds to the spray device 100 having an extended spray reach via the extender 332.

The nozzle assembly 318 rotates around a rotation axis that is about at a 45° angle relative to both the horizontal and vertical axes. However, in the first and second spray configurations, the nozzles 328, 330 are positioned relative to the horizontal and vertical directions. As such, the nozzles 328, 330, via the nozzle manifold 324, are oriented in oblique directions relative to the rotation axis of the nozzle assembly 318. In an aspect, the oblique angles are about a 45° angle. The nozzles 328, 330 are substantially orthogonal to one another. In the example, the nozzle 328, 330 that is positioned orthogonally relative to the minor sidewall 310b is configured to discharge a fluid spray when the actuator 320 is engaged by the user.

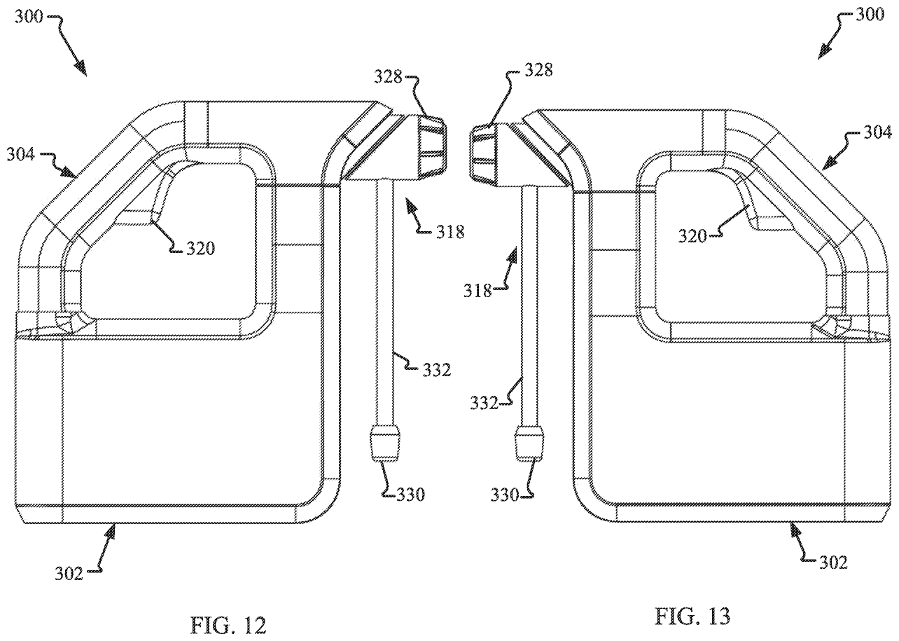

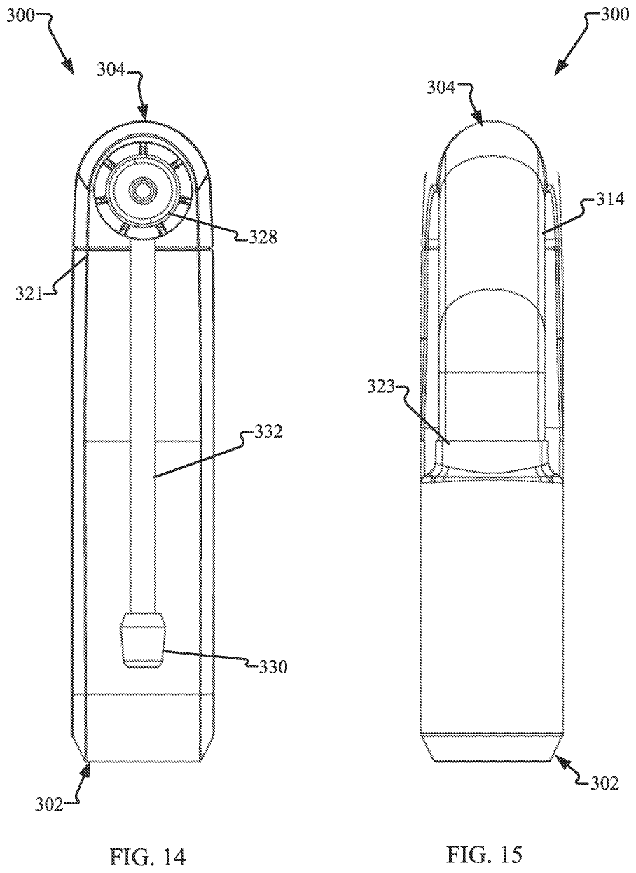

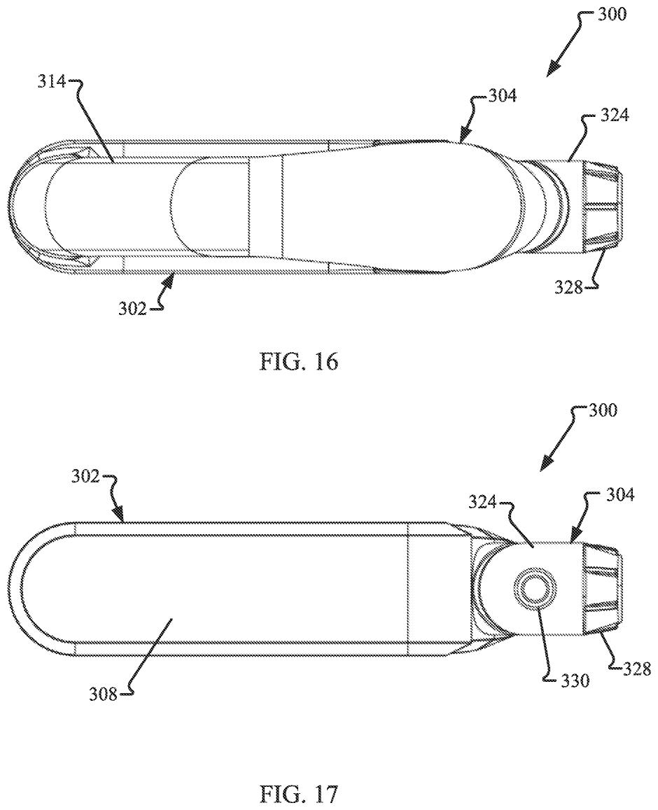

FIGS. 12-15 are side elevation views of the spray device 300. FIG. 16 is a top view of the spray device 300. FIG. 17 is a bottom view of the spray device 300. Referring concurrently to FIGS. 12-17, the components of the spray device 300 are described above, and thus, are not necessarily described further. These additional views of the spray device 300 are provided for completeness and illustrate the spray device 300 in the first spray configuration.

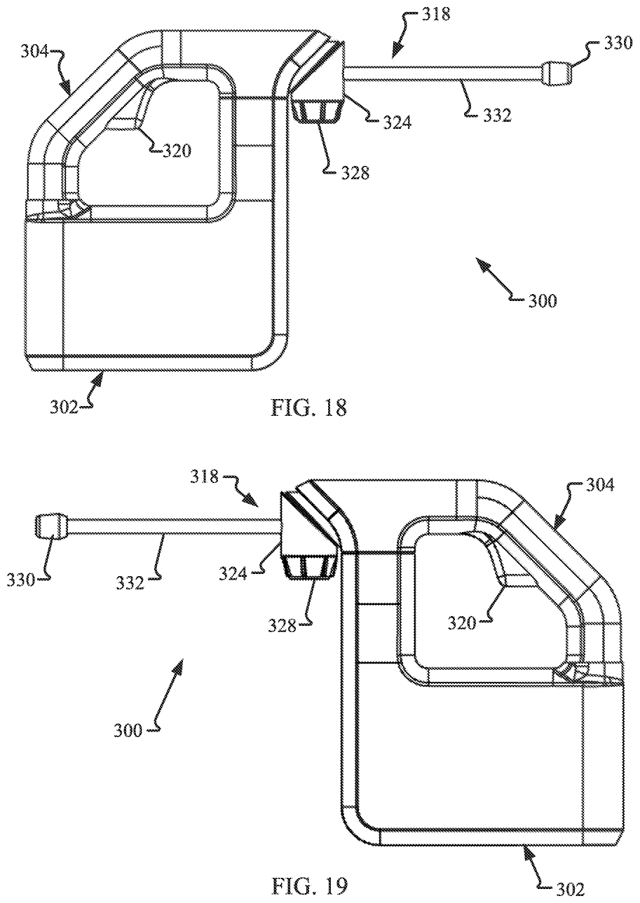

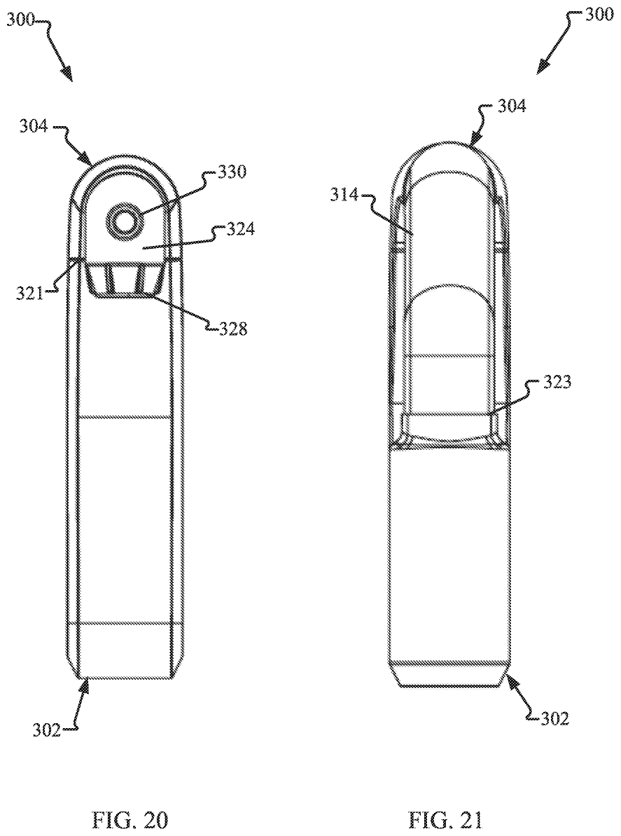

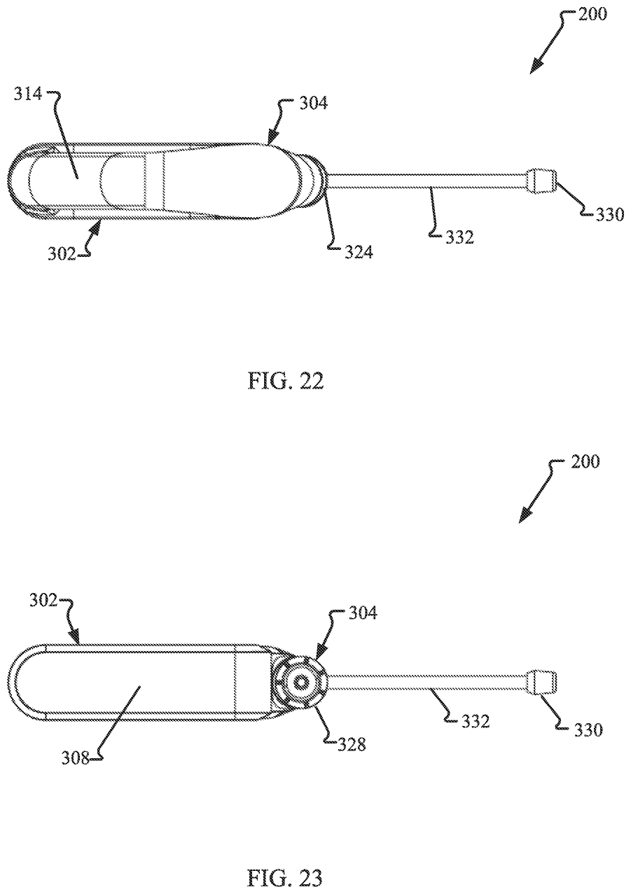

FIGS. 18-21 are side elevation views of the spray device shown 300. FIG. 22 is a top view of the spray device 300. FIG. 23 is a bottom view of the spray device 300. Referring concurrently to FIGS. 18-23, the components of the spray device are described above, and thus, are not necessarily described further. These additional views of the spray device 300 are provided for completeness and illustrate the spray device 300 in the second spray configuration.

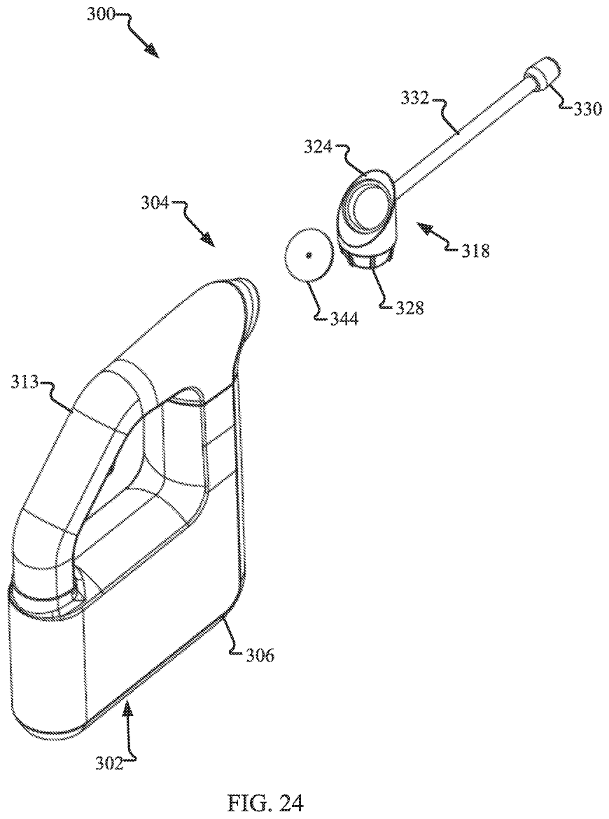

FIG. 24 is a partial exploded perspective view of the spray device 300. As illustrated in FIG. 24, the housing 313 is coupled to the container body 306 of the container 302. The nozzle assembly 318 includes both nozzles 328, 330 coupled to the nozzle manifold 324. The nozzle assembly 318 can include a stop indent 344 for registering the nozzle manifold 324 in both the first and second spray configurations as described above. The stop indent 344 may provide an audible and/or a tactile register when the nozzle manifold 324 is moved into the first and second spray configurations.

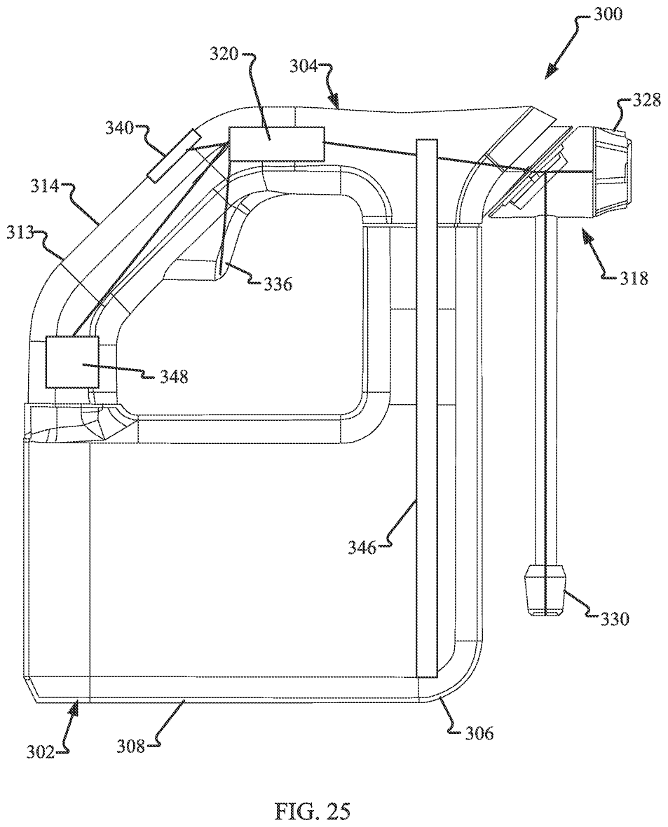

FIG. 25 is a cross-sectional schematic view of the spray device 300. As illustrated in FIG. 25, the operational components of the spray device 300 are shown schematically. Within the container body 306, a dip tube 346 extends towards the bottom wall 308 and is configured to allow the fluid contained within the container 302 to be extracted by the sprayer assembly 304. Once the fluid is extracted from the container 302, a fluid circuit within the nozzle assembly 318 enables the fluid to be selectively discharged from one of the nozzles 328, 330. The actuator 320 is disposed within the housing 313 of the sprayer assembly 304 and can be located proximate the handle 314. The actuator 320 can include a battery powered pump mechanism so as to pressurize the fluid for discharge from the nozzle assembly 318. The actuator 320 is operatively coupled to both the trigger element 336 and the lock 340. In some aspects, a battery chamber 348 is provided within the housing 313 so as to receive a power source.

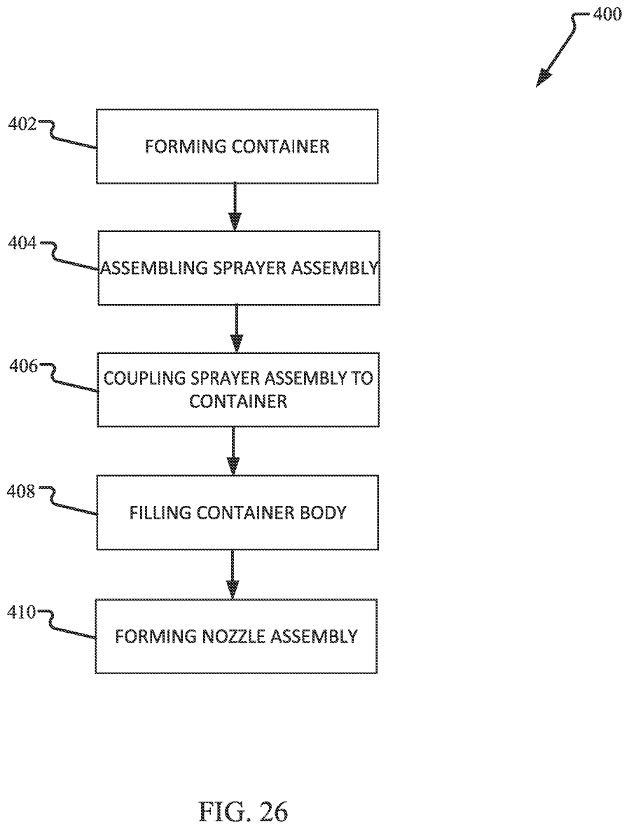

FIG. 26 illustrates a flowchart illustrating a method 400 of manufacturing a spray device for dispensing fluid. The example methods and operations can manufacture and assemble the devices described herein (e.g., spray devices 100, 200, 300). The method 400 begins with forming a container having a container body configured to hold fluid to be dispensed (operation 402). Additionally, a sprayer assembly is assembled (operation 404). The sprayer assembly may include a housing rotatably supporting a nozzle assembly and supporting an actuator. The nozzle assembly has at least a first nozzle and a second nozzle, the first nozzle discrete and separated from the first nozzle on the nozzle assembly. The nozzle assembly being rotatable between at least two spray configurations.

The sprayer assembly is then coupled to the container (operation 406) so that the actuator is configured to selectively dispense fluid from the sprayer assembly via the nozzle assembly and in a first spray configuration whereby the actuator dispenses fluid from the first nozzle and a second spray configuration whereby the actuator dispenses fluid from the second nozzle. In some examples, coupling the sprayer assembly to the container may include removably connecting the housing to the container body with a threaded connector, a rotating connection, a bayonet connection, or a press connection.

In some examples, the method 400 further includes filling the container body with fluid (operation 408). The fluid can be one or more of a pesticide, a herbicide, or a fungicide as required or desired. In other examples, the method 400 may further include assembling the sprayer assembly includes forming the nozzle assembly (operation 410) with the first nozzle oriented in an orthogonal direction relative to the second nozzle.

As described above, the spray devices have a rotatable sprayer tip so that different spray patterns can be switched between. For example, the different spray patterns may be spray and stream, or any other pattern as required or desired. The sprayer tip has two different nozzles and can rotate in either direction so as to change between nozzles and spray patterns. The spray devices can be formed from a container and a sprayer assembly being aesthetically and ergonomically integrated together. The sprayer assembly may be useable with replacement containers. In aspects, the sprayer assembly may be battery powered. The sprayer assembly may have a lock feature to reduce or prevent accidental trigger activation.

The technologies described herein relate to another spray device having a detachable wand. As described, use of the spray device can include barrier treatments, whereby a large area is treated with the fluid within the spray device, and spot treatments, whereby a smaller area is treated with the fluid within the spray device. The detachable wand can be used by the user so that spot treatment(s) can easily be addressed without needing to move the entire spray device around. However, the wand can still be attached to the container so that users may also provide a barrier treatment and use over prolonged periods of time. The wand is filled from the container and has its own smaller reservoir for the spot treatments. In aspects, the wand may be battery powered. The remote wand is detachable with a button, pinch release, or any other form of quick connect/detach feature. The wand may have a lock feature to reduce or prevent accidental trigger activation and accidental fluid dispense. The nozzle of the wand may include an extendable feature for more accurate fluid discharge feature.

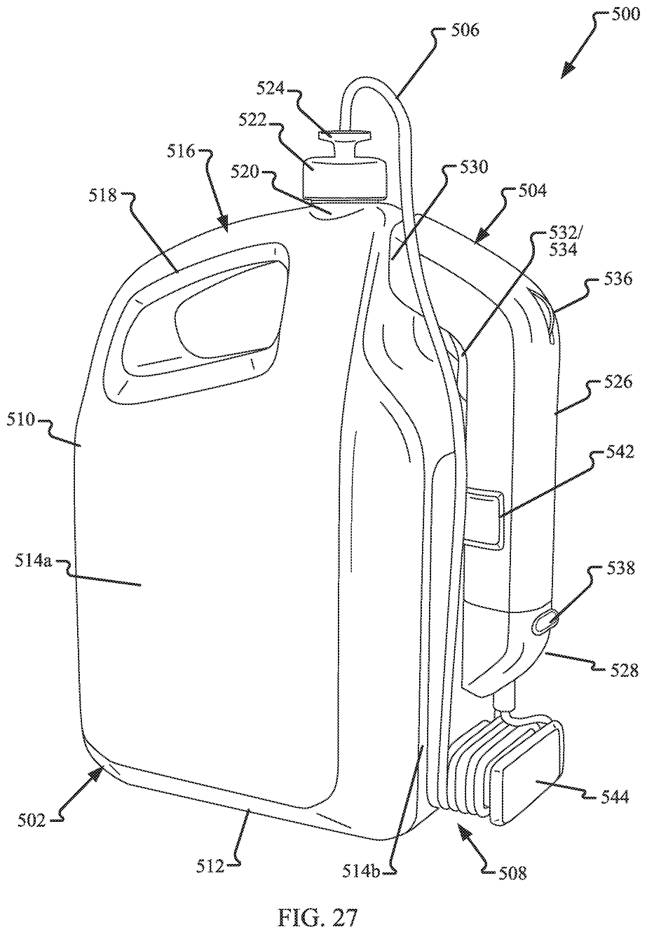

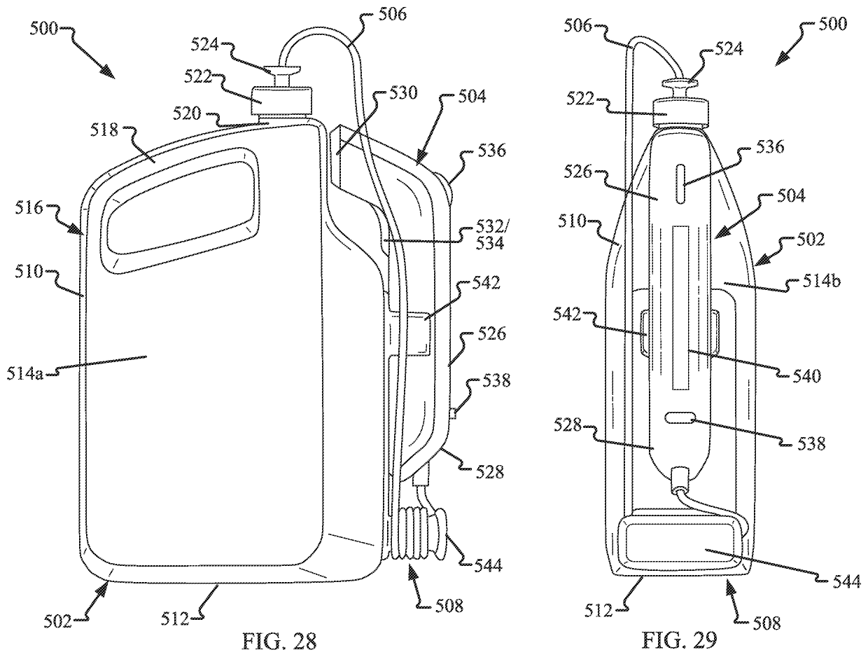

FIG. 27 a perspective view of an exemplary spray device 500. FIG. 28 is a side elevation view of the spray device 500. FIG. 29 is another side elevation view of the spray device 500. Referring concurrently to FIGS. 27-29, the spray device 500 is configured to retain and selectively dispense fluid therefrom. In examples, the fluid may be a formulation such as a pesticide, a herbicide, a fungicide, or the like and a user utilizes the spray device 500 as a treatment for indoor or outdoor areas. For example, the fluid may be an insecticide (e.g., a type of pesticide) for an indoor or outdoor foundation treatment to kill and/or control insects. In another example, the fluid may be a herbicide or a fungicide for outdoor lawn or plant area treatment to kill and/or control weeds, diseases, fugus, or the like. It should be appreciated, that the spray device 500 described herein can be used with any other type of fluid as required or desired. For example, the fluid can be, but is not limited to, a cleaner solution, a stain remover, water, etc. In an aspect, the fluid can be a floor cleaner, a kitchen or bath cleaner, leather or fabric cleaner, outdoor cleaner, a sanitizer of disinfectant, and the like. The spray device 500 is configured to discharge fluids that are both viscous and emulsions.

In the example, the spray device 500 includes a container 502, a wand assembly 504, a flexible hose 506, and a mount 508. The container 502 includes a container body 510 forming a hollow interior configured to hold the fluid to be dispensed. The container body 510 may be formed from a plastic-based material according to known molding processes, and shaped and sized to hold between 32-250 ounces of fluid. In an aspect, the container 502 may be pre-filled with fluid so that the user may purchase the container 502 in a substantially usable condition without needing to mix, fill, or stir the fluid contained therein.

The container body 510 has a bottom wall 512 so that the spray device 500 can stand up-right on its own and one or more sidewalls 514 that at least partially define the shape of the container 502. In the example, the sidewalls 514 have a substantially rectangular shape with a pair of opposing major sidewalls 514a and a pair of opposing minor sidewalls 514b. The major sidewalls 514a may be used for product labeling, while the minor sidewalls 514b may be used for supporting the wand assembly 504. In other examples, the minor sidewalls 514b may be used for product labeling, while the major sidewalls 514a may be used for supporting the wand assembly 504.

Opposite the bottom wall 512, the container body 510 has a top portion 516. The top portion 516 may form a handle 518 that accommodates a grip of the user's hand. As such, the spray device 500 can be considered a hand-held sprayer having an appropriate size and weight for handling by the user without undue strain and without external assistance in the form of a carriage or other supporting means. Alternatively, it is to be understood that the handle 518 may be omitted and the spray device 500 can still be considered a hand-held sprayer. Additionally, the top portion 516 also forms a neck 520 having opening that enables the fluid to be received by, and extracted from within, the container body 510. In the example, the neck 520 is substantially cylindrical and configured to receive a cap 522. The cap 522 is configured to sealingly engage with the container body 502.

A dip tube (not shown) is coupled to the cap 522 and extends into the interior of the container body 510 towards the bottom wall 512. A coupler 524 is connected to the cap 522 and establishes fluid communication with the dip tube. The coupler 524 also extends outward from the cap 522 and the hose 506 is configured to attach to the coupler 524 so that the fluid can be extracted from the container body 510. The hose 506 extends between the coupler 524 and the wand assembly 504 so that the wand assembly 504 and the container 502 are coupled in fluid communication.

The wand assembly 504 is configured to discharge the fluid from the spray device 500. The wand assembly 504 includes a wand body 526 that is releasably coupled to a hose connector 528 at a first end. The wand body 526 supports a nozzle 530 at an opposite second end and an actuator 532 configured to selectively dispense fluid from the wand assembly 504 via the nozzle 530 when actuated by the user. The hose connector 528 receives the hose 506 so that the wand assembly 504 receives fluid from the container 502.

In operation, the wand body 526 is configured to dispense fluid both while being engaged with the hose connector 528 (as illustrated) and when disengaged from the hose connector 528. For example, in the configuration illustrated in FIGS. 27-29, the wand body 526 is engaged with the hose connector 528 such that the entire wand assembly 504 is fluidly coupled to the container 502 via the hose 506. In this configuration, the user can remove the wand assembly 504 from the mount 508 and unwrap at least a portion of the hose 506. As such, the wand assembly 504 can be moved relative to the container 502 while discharging fluid via the nozzle 530 and actuator 532. However, the reach of the wand assembly 504 is limited by the length of the hose 506. Because of the handle 518 on the container body 510, the spray device 500 can be moved around by the user as required or desired. In aspects, this configuration of the spray device 500 is suitable for treating large surface areas because the fluid stored within the container 502 is channeled through the wand assembly 504. In examples, treatment of large surface areas may be referred to as a boundary treatment.

However, for treatment of smaller surface areas that may be referred to as spot treatments, the wand body 526 can disengage from the hose connector 528. The wand body 526 has its own internal refillable reservoir that can hold a charge of the fluid so that the user can discharge fluid via the nozzle 530 and actuator 532 while the wand assembly 504 is disconnected from the container 502 and completely remote therefrom. In this configuration, the user can leave the container 502 in one area and only move a portion of the wand assembly 504 around to different areas for spot treatments. The reach of the wand body 526 here is not limited by the length of the hose 506, because of the charge of fluid that is dispensed is stored within the wand body 526. Once the spot treatment(s) are completed, the user can re-engage the wand body 526 with the hose connector 528 and re-mount the wand assembly 504 to the container body 510 for storage. By being able to operate the wand assembly 504 completely remote from the container 502, the user can more easily discharge the fluid for spot treatments, and it is not required to move the heavier container 502 around.

In the example, the reservoir within the wand body 526 is filled from the liquid within the container 502. The reservoir, however, has a smaller volume than the container body 510. For example, the reservoir may hold a volume of liquid that enables between 5-10 sprays from the nozzle 530. In an aspect, the reservoir is incorporated in series within the fluid circuit of the wand body 526 that channels fluid from the hose 506 at the hose connector 528, through the reservoir, and then discharged at the nozzle 530. In this configuration, the reservoir maintains its fill level when the wand body 526 is engaged with the hose connector 528 and the wand assembly 504 is being used. The charge of fluid within the reservoir may be depleted when the wand body 526 is used on its own. Once the wand body 526 is re-engaged with the hose connector 528, the actuator 532 may be used to refill the reservoir.

In other aspects, the wand body 526 may have two parallel fluid circuits. A first circuit that directly channels fluid from the hose 506 at the hose connector 528 to the nozzle 530 for discharge. A second circuit may have the reservoir therein. In operation, the wand assembly 504 can selectively engage the first or second circuit depending on if the wand body 526 is engaged with the hose connector 528 or not. In this example, the reservoir can automatically be refilled or checked for refilling every time the wand body 526 is engaged with the hose connector 528. Additionally, by using two separate fluid circuits, the discharge characteristics (e.g., flow rate, pressure, etc.) of the fluid can be specifically tailored for boundary or spot treatments as required or desired.

The actuator 532 includes a spring-loaded trigger element 534 that is pivotably mounted to the wand body 526. The trigger element 534 is coupled in communication with a battery powered pump mechanism (not shown) disposed within the wand body 526 and is in fluid communication with the hose connector 528 so that fluid can be pumped through the wand assembly 504 and discharged at the nozzle 530. In operation, the user can squeeze the trigger element 534 to energize the pump mechanism and pump fluid from the container 502, through the hose 506, and to the nozzle 530 wherein the fluid is discharged from the spray device 500. Continuous spraying of fluid may be accomplished without repetitive actuation of the trigger element 534 by holding the trigger element 534 in an activated position (e.g., depressed). When the trigger element 534 is released, the trigger element returns to a deactivated position and deenergizes the pump mechanism. In this example, the wand body 526 also include a battery chamber (not show) that allows the user to replace the batteries as required or desired.

In other aspects, the wand assembly 504 may not be battery operated. Rather, the trigger element 534 is coupled in communication with a mechanical pump mechanism disposed within the wand body 526. In this example, the user must use the trigger element 534 as a pump lever and so as to create fluid pressure in order to discharge the fluid from the nozzle 530. As such, every squeeze of the trigger element 534 may generate a discharge spray of fluid.

In the example, the wand body 526 is substantially L-shaped with the nozzle 130 at the end of the short leg and the coupling to the hose connector 528 at the end of the long leg. The short leg and the long leg may be at least partially angled relative to one another with the trigger element 534 mounted at the inner surface. On an opposite outer surface of the wand body 526, the actuator 532 may include a lock 536 for the trigger element 534 so as to prevent accidental fluid dispense.

The wand body 526 is releasably coupled to the hose connector 528 as described above. This coupling not only enables the wand body 526 to be removed from the hose connector 528, but also establishes fluid communication between the wand body 526 and the hose 506 when connected. As illustrated, a button 538 is used to facilitate the wand body 526 detaching from the hose connector 528. It is appreciated, however, that other types of couplings that enable a quick connect/detach functionalities can be used as required or desired, such as, but not limited to a pinch release coupling. By using a button or a pinch release, the user can disconnect the wand body 526 with use of only one hand. As illustrated in FIGS. 27-29, the button 538 is disposed on the hose connector 528, however, alternatively, the button 538 may be disposed on the wand body 526.

The nozzle 530 may be a rotatable nozzle so that the manner of discharge of the fluid flowing through the wand assembly 504 can be changed. In an aspect, rotation of the nozzle 530 may change the discharge between at least a conical stream configuration and a fanned spray configuration. As such, the nozzle 530 can have two or more different discharge configurations, for example, a spray, a stream, a fan, a cone, etc. In other aspects, a conical spray configuration may be used. Additionally or alternatively, the nozzle 530 may have other features as required or desired. In one example, the nozzle 530 may be mounted on an extender (not shown). The extender may selectively extend and retract from the wand body 526 so that the user can position the nozzle 530 closer to the area to be treated. In other examples, the extender may rotate relative to the wand body 526 and provide extension therefrom. In still other examples, the extender may both extend and rotate as required or desired. In an aspect, the nozzle 530 is shaped and sized to discharge fluids having viscosity up to 800 centipoise and discharge an average spray particle size of between 20 to 200 microns.

The wand body 526 may also include a window 540 into the reservoir so that the user can see the fill volume of the reservoir. The window 540 may also provide a way for the user to know/see if the wand assembly 504 is primed.

The wand assembly 504 is configured to be to be stored on the container 502 by the mount 508. The mount 508 releasably couples the wand body 526 to the container body 510. As illustrated in FIGS. 27-29, the mount 508 includes a clip 542 that releasably secures to the outer surface of the wand body 526. The clip 542 allows for the user to remove the wand assembly 504 from the mount 508 one-handed. Alternatively or alternatively, any other mechanical fastener may be used on the mount 508 to releasably secure the wand body 526, such as, but not limited to, a magnet, a locking feature, or the like. In an aspect, the clip 542 or other locking feature may have an audible and/or tactile feedback when the wand body 526 is being attached and/or removed.

The mount 508 may include a hose wrap 544 that is configured to store at least a portion of the hose 506 in a wrapped configuration when stored. In the example, the hose wrap 544 is interconnected with the mount 508 and extends from the minor sidewall 514b of the container body 510. The hose wrap 544 may be disposed below the clip 542 on the mount 508. The hose wrap 544 is elongated between the major sidewalls 514a and in a horizontal direction relative to the container 502. In aspects, the hose wrap 544 may be integrally formed within the mount 508 and in conjunction with the clip 542. In still other aspect, the clip 542 and the hose wrap 544 may be discrete components either attached to, or formed with, the container body 510.

In the example, the mount 508 may be coupled to the container body 510. In an aspect, the mount 508 may be permanently attached to the container 502, while in other aspects, the mount 508 may be integrally formed with the container body 510 and in the same molding process. In still other examples, the mount 508 may be coupled to the container body 510 so that the mount 508, and thus, the hose 506 and the wand assembly 504, are removable from the container body 510. By enabling the mount 508 to detach from the container body 510, the spray device 500 can have the mount 508, the hose 506, and the wand assembly 504 be reusable and transferable to replaceable containers 502 so that replacement containers 502 are economically more efficient.

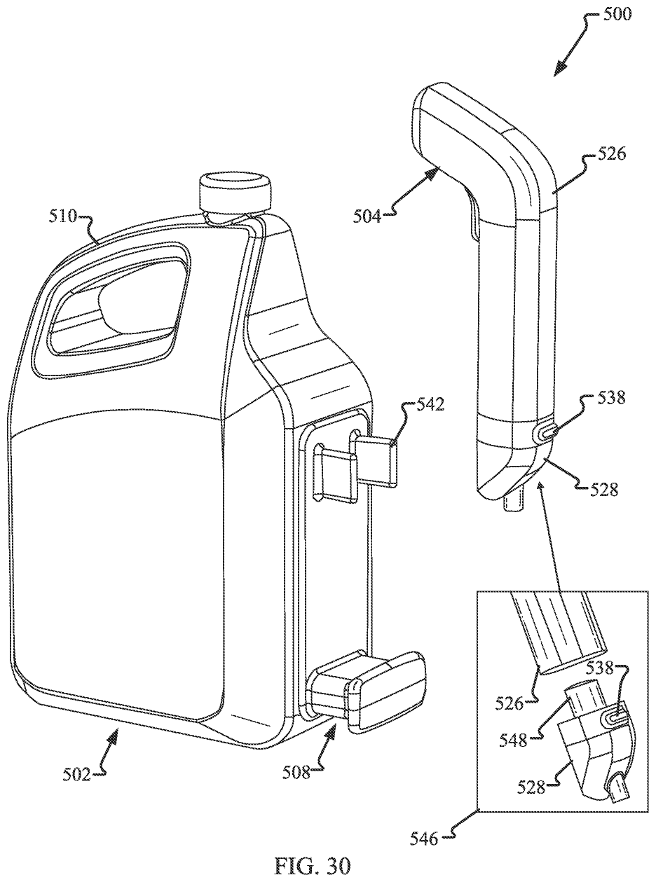

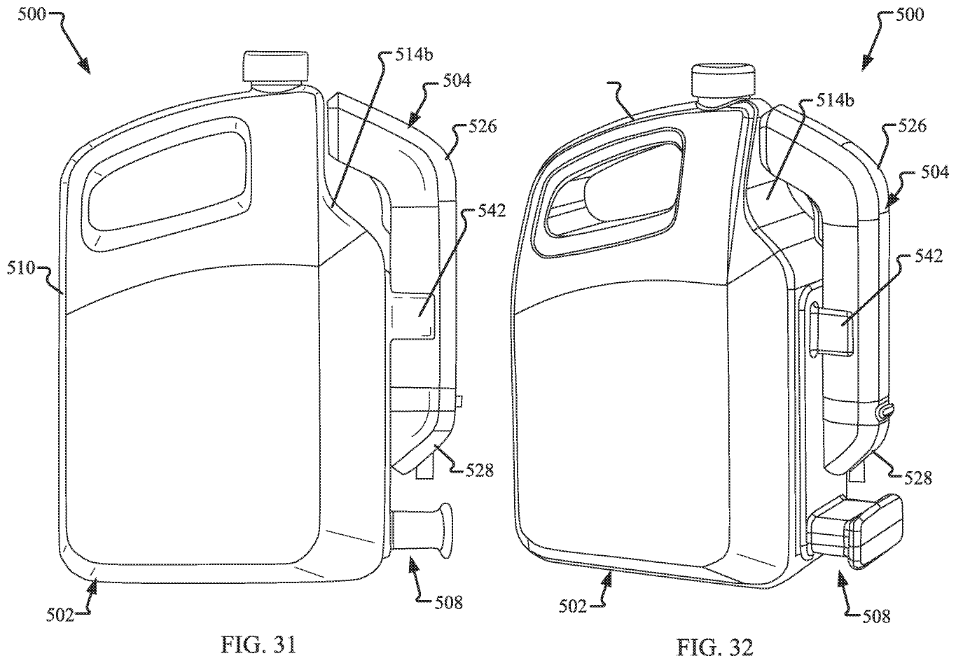

FIG. 30 is a partial exploded perspective view of the spray device 500. FIG. 31 is a side elevation view of the spray device 500. FIG. 32 is a partial perspective view of the spray device 500. Referring concurrently to FIGS. 30-32, the hose 506 (shown in FIGS. 27-29) is not illustrated for clarity. Starting with FIG. 30, the wand assembly 504 is shown as detached from the mount 508 that is disposed on the container body 510. In this detached configuration the wand assembly 504 can be used to spray the fluid that is contained within the container body 510. Additionally, as illustrated in the enlarged box 546, the wand body 526 can be disengaged from the hose connector 528 so that the wand body 526 can be completely remote from the container 502 while having its own charge of fluid for discharge within the reservoir therein. The button 538 may be used to disengage the wand body 526 from the hose connector 528.

In the example, the hose connector 528 may have a post 548 extending therefrom and opposite of the hose inlet. The post 548 is shaped and sized to be received by the wand body 526 so as to increase the engagement strength therebetween. Additionally, the post 548 enables the fluid to flow between the hose connector 528 and the wand body 526 when the wand body 526 is engaged with the hose connector 528. The clip 542 on the mount 508 includes a pair of projections that extend outwards and that are configured to releasably connect the wand assembly 504 to the container 502. In the example, the wand body 526 is coupled to the container 502, while the hose connector 528 does not independently connect to the container 502.

Turning now to FIGS. 31 and 32, the inner surface of the L-shaped wand body 526 may correspond in shape to the outer surface of the minor sidewall 514b. As such, when the wand assembly 504 is attached to the container body 510, the overall shape and size of the spray device 500 is aesthetically pleasing and compact.

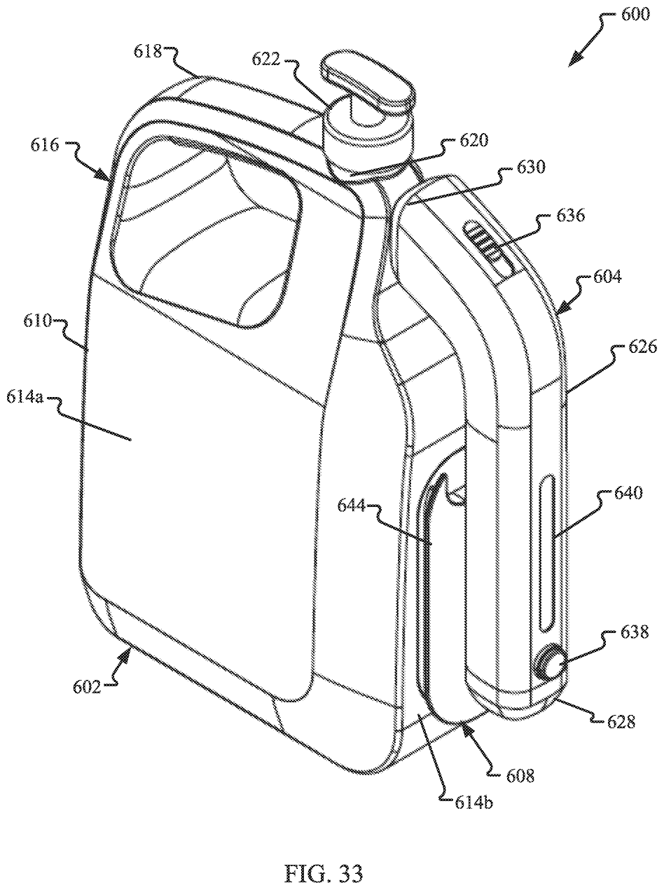

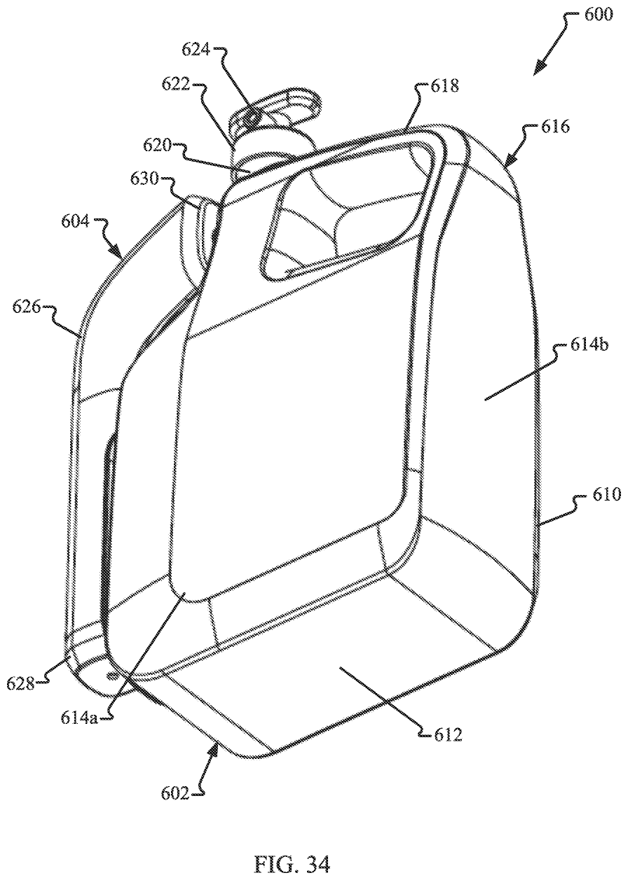

FIG. 33 is a perspective view of another spray device 600. FIG. 34 is another perspective view of the spray device 600. Referring concurrently to FIGS. 33 and 34, the spray device 600 is similar to the spray device 500 and is configured to retain and selectively dispense fluid therefrom. The spray device 600 includes a container 602, a wand assembly 604, and a mount 608. A flexible hose is not illustrated for clarity but extends between the container 602 and the wand assembly 604 for fluid communication therebetween. The container 602 has a container body 610 forming a hollow interior configured to hold the fluid to be dispensed.

The container body 610 has a bottom wall 612 so that the spray device 600 can stand up-right and pairs of opposing major and minor sidewalls 614a, 614b. One of the minor sidewalls 614b includes the mount 608 and may be used for supporting the wand assembly 604. A top portion 616 of the container body 610 may form a handle 618 and a neck 620 having an opening that enables the fluid to be received by, and extracted from within, the container body 610. In the example, the neck 620 is configured to receive a cap 622 for sealing the container body 610.

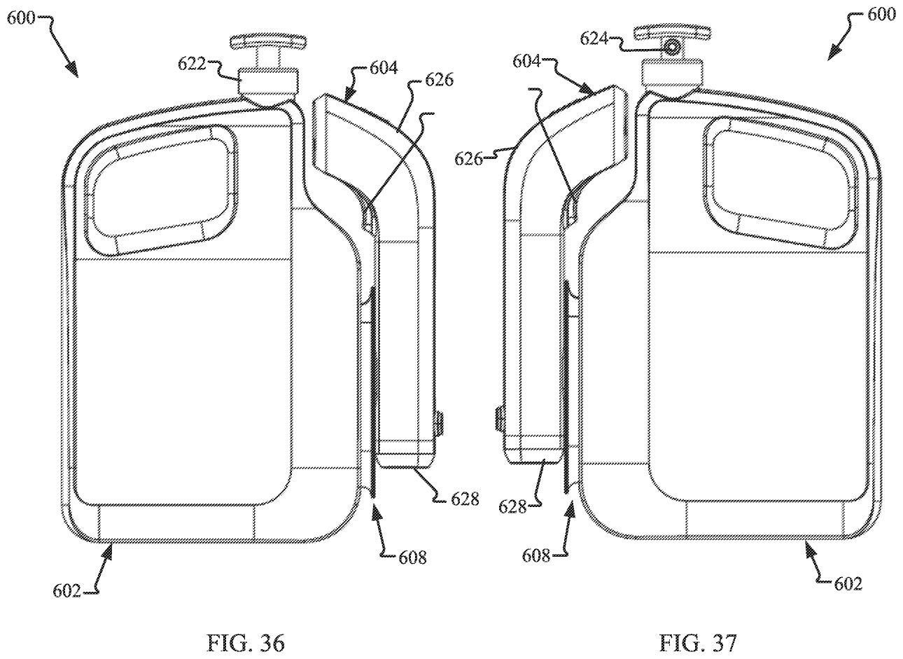

A dip tube (not shown) is coupled to the cap 622 and a coupler 624 is connected to the top of the cap 622. In this example, the coupler 624 extends from a side of the cap 622, however, it is similarly configured to receive the hose (not shown). The wand assembly 604 includes a wand body 626 having a reservoir (not shown), a hose connector 628, a nozzle 630, and an actuator 632 (shown in FIGS. 36 and 37) is configured to selectively dispense fluid from the container 602. In operation, the wand body 626 is configured to dispense fluid while being engaged with the hose connector 628 (as illustrated) for boundary treatment(s) and when disengaged from the hose connector 628 for spot treatment(s).

The actuator 632 includes a spring loaded trigger element 634 (shown in FIGS. 36 and 37) that selectively enables discharge of fluid from the wand assembly 604 as described herein. The actuator 632 may also include a lock 636 for the trigger element 634. In this example, the lock 636 is slidable between a locked position and an unlocked position, and the lock 636 is positioned on the outside of the short leg in a direction towards the nozzle 630 position. A button 638 may be used to facilitate the wand body 626 detaching from the hose connector 628. In this example, the button 638 is disposed on the wand body 626. The nozzle 630, similar to the nozzle described above, may be configured to discharge one or more different spay configurations, and in some examples, be mounted on an extender as required or desired. A window 640 is also provided on the wand body 626.

In this example, the mount 608 is configured to releasably couple the wand body 626 to the container body 610 and includes a hose wrap 644 that is configured to store at least a portion of the hose in a wrapped configuration. The hose wrap 644 is positioned between the minor sidewall 614b of the container body 610 and the wand body 626 when the wand assembly 604 is attached thereto. The hose wrap 644 is elongated in a top-bottom vertical direction relative to the container 602.

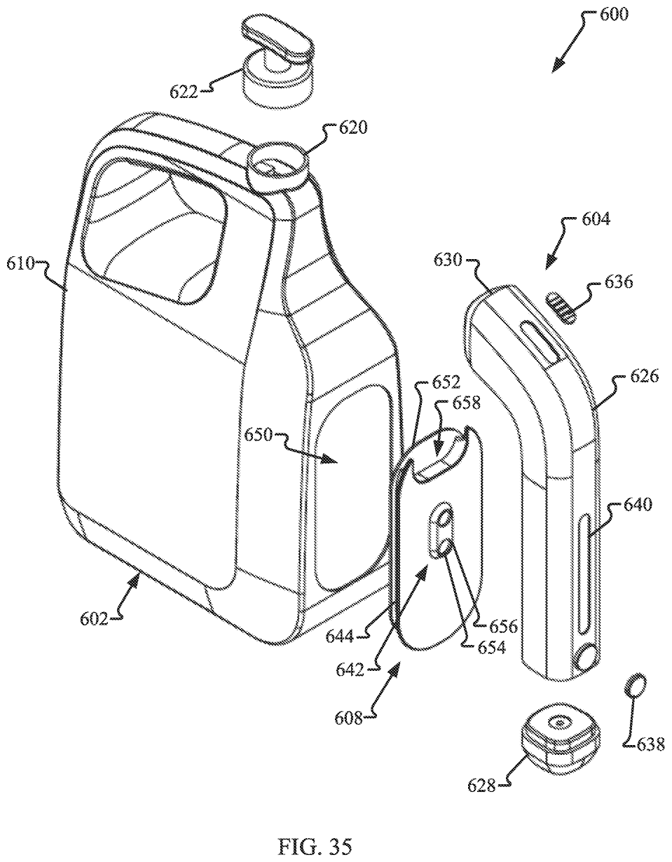

FIG. 35 is an exploded perspective view of the spray device 600. Certain components are described above, and thus, are not necessarily described further. The container body 610 includes a recess 650 configured to receive at least a portion of the mount 608. The mount 608 includes a rear plate 652 that engages with the recess 650. A front surface of the mount 608 includes a clip 642 that releasably secures to the wand body 626. In this example, the clip 642 includes magnetic elements 654 that engage with corresponding element(s) on the wand body 626. The magnetic elements 654 may be supported on a lug 656 extending from the front surface of the mount 608. The hose is configured to wrap at least partially around the mount 608 via the hose wrap 644 and the hose is received between the front surface and the rear plate 652. The hose wrap 644 may include a notch 658 for hose management by the user. The mount 608 may be interconnected to or integrally formed with the container body 610. In other examples, the mount 608 may be removably connected to the container body 610. As shown, the mount 608 is connected to a minor sidewall, however, additionally or alternatively, the mount 608 may be connected to a major sidewall. In this configuration, the wand body 626 and/or the hose wrap 644 may be located at the major sidewall of the container body 610 as required or desired.

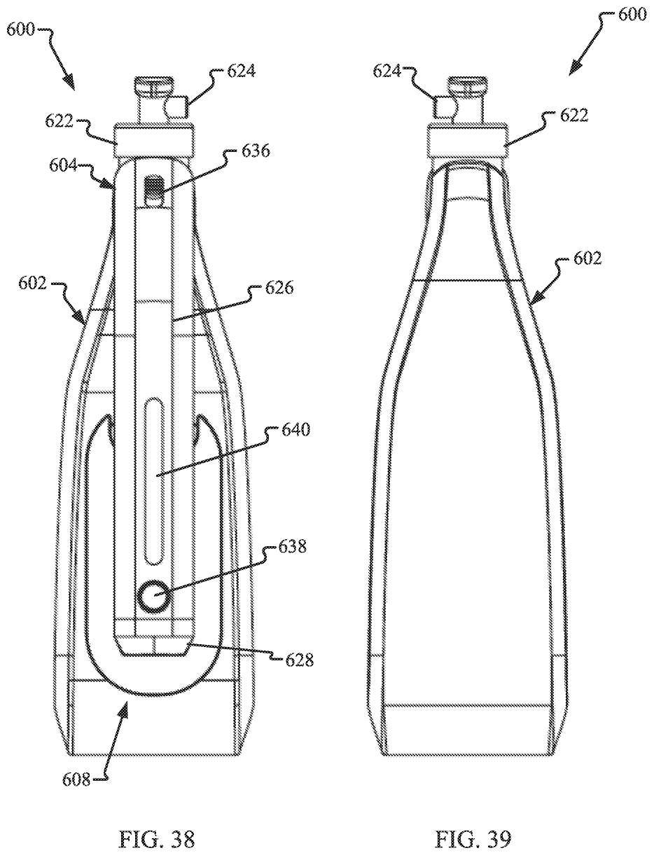

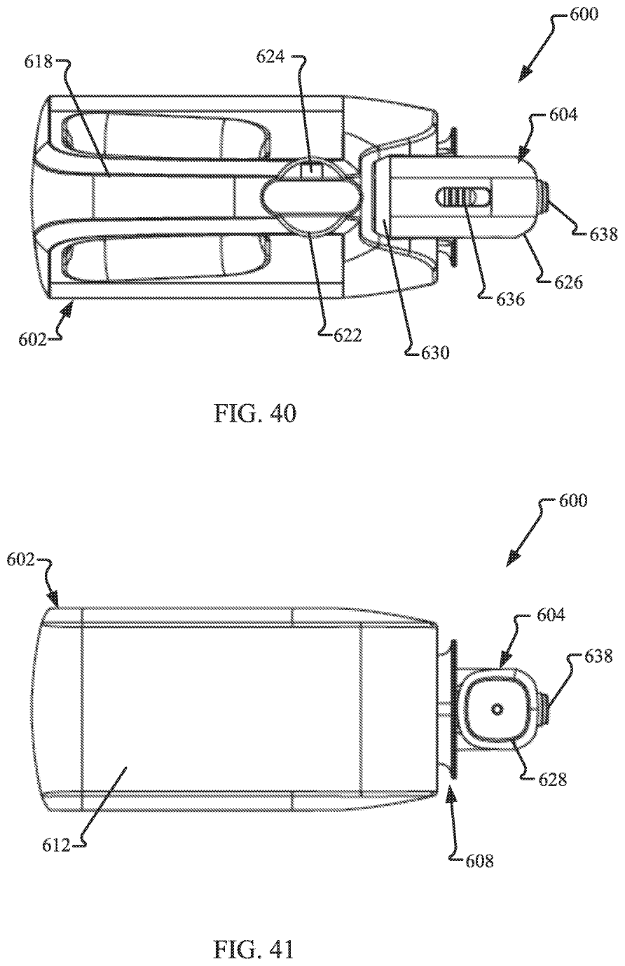

FIGS. 36-39 are side elevation views of the spray device 600. FIG. 40 is a top view of the spray device 600. FIG. 41 is a bottom view of the spray device 600. Referring concurrently to FIGS. 36-41, the components of the spray device 600 are described above, and thus, are not necessarily described further. These additional views of the spray device 600 are provided for completeness.

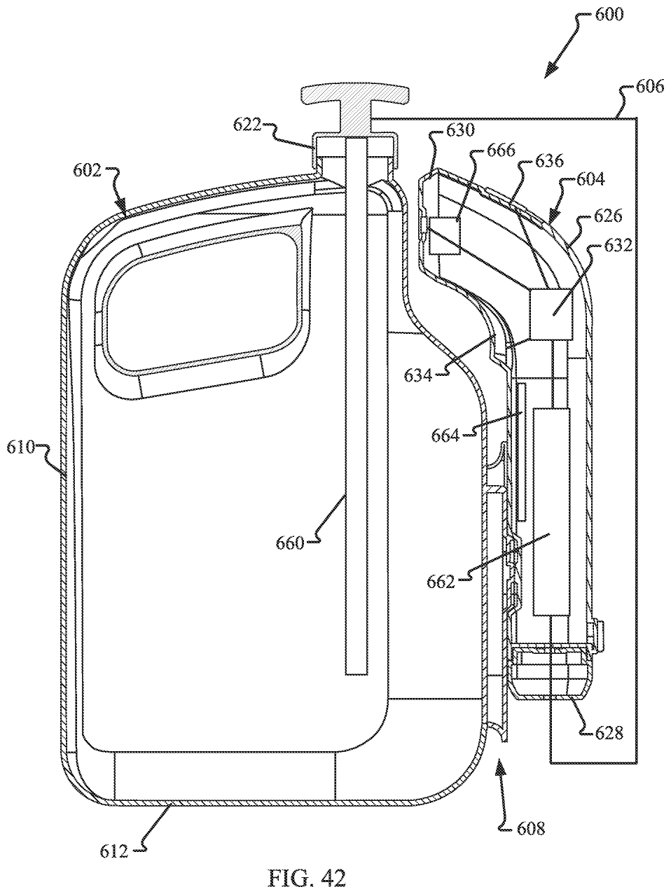

FIG. 42 is a cross-sectional schematic view of the spray device 600. As illustrated in FIG. 42, the operational components of the spray device 600 are shown schematically. Within the container body 610, a dip tube 660 extends towards the bottom wall 612 and is configured to allow the fluid contained with the container 602 to be extracted out of the cap 622. Once the fluid is extracted from the container 602, a hose 606 enables the fluid to be channeled towards the wand assembly 604. The hose 606 may be stored at the mount 608 as required or desired. The wand assembly 604 includes a fluid circuit that enables the fluid to be selectively discharged from the nozzle 630.

In the example, the wand body 626 includes a reservoir 662 configured to hold a charge of the fluid. The reservoir 662 is in fluid communication with the hose 606 and through the hose connector 628. The fluid circuit through the hose connector 628 allows the wand body 626 to disengage while restricting fluid from flowing out of the connection end. The actuator 632 is disposed within the wand body 626 and can include a battery powered pump mechanism so as to pressurize the fluid for discharge from the nozzle 630. The actuator 632 is operatively coupled to both the trigger element 634 and the lock 636. In some aspects, a battery chamber 664 is provided within the wand body 626 so as to receive a power source. Additionally, an extender 666 may be provided for the nozzle 630 so that the reach of the nozzle 630 from the wand body 626 is selectively extendable.

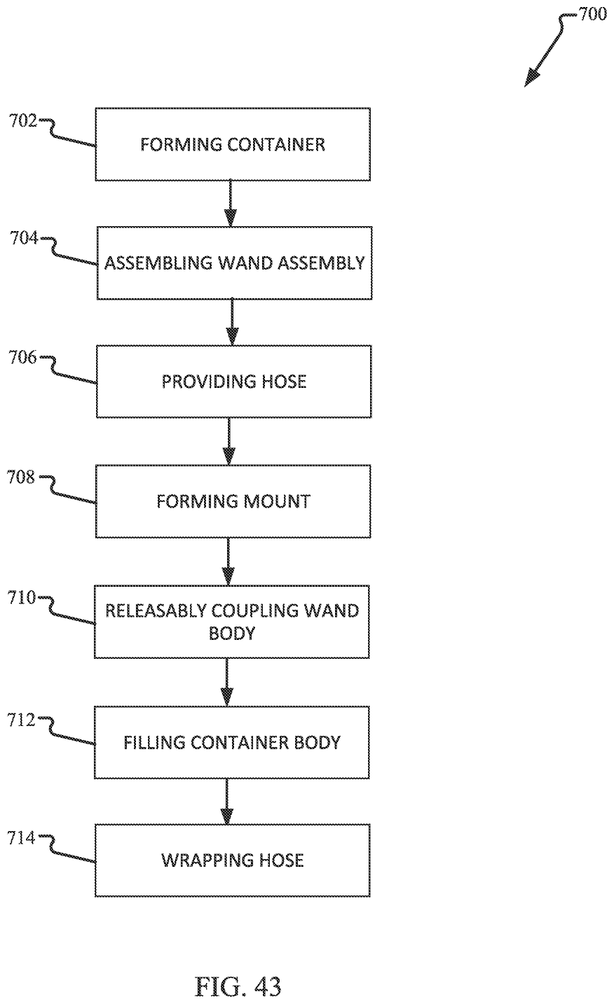

FIG. 43 illustrates a flowchart illustrating a method 700 of manufacturing a spray device for dispensing fluid. The example methods and operations can manufacture and assemble the devices described herein (e.g., spray devices 500, 600). The method 700 begins with forming a container having a container body configured to hold fluid to be dispensed (operation 702). Additionally, a wand assembly is assembled (operation 704). The wand assembly may include a wand body with a reservoir configured to hold a charge of the fluid to be dispensed, a nozzle, and actuator configured to selectively dispense fluid from the wand assembly via the nozzle, and a hose connector that releasably couples to the wand body.

A hose is provided that couples the wand assembly to the container in fluid communication (operation 706). A mount is also formed (operation 708). The wand body can then be releasable coupled to the container body via the mount so as to manufacture the spray device (operation 710). The spray device once manufactured enables for when the wand body is engaged with the hose connector, the wand assembly to dispense fluid while being connected to the container via the hose, and when the wand body is disengaged from the hose connector, the wand assembly to dispense fluid from the reservoir while the wand body is disconnected from the container and completely remote therefrom. In some examples, the wand body can be formed with a battery chamber such that the wand assembly is battery powered.

In some examples, the method 700 further includes filling the container body with fluid (operation 712). The fluid can be one or more of a pesticide, a herbicide, and a fungicide as required or desired. In other examples, the method 700 may further include wrapping at least a portion of the hose around a hose wrap (operation 714).

As described above, the spray devices have a detachable wand that is to be used by the user so that spot treatment(s) can easily be addressed without needing to move the entire spray device around. However, the wand can still be attached to the container so that users may also provide a barrier treatment and use over prolonged periods of time. The wand is filled from the container and has its own smaller reservoir for the spot treatments. In aspects, the wand may be battery powered. The remote wand is detachable with a button, pinch release, or any other form of quick connect/detach feature. The wand may have a lock feature to reduce or prevent accidental trigger activation. The nozzle of the wand may include an extendable feature for a more accurate discharge feature.

This disclosure describes some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art. Any number of the features of the different examples described herein may be combined into one single example and alternate examples having fewer than or more than all of the features herein described are possible. Further, as used herein and in the claims, the phrase “at least one of element A, element B, or element C” is intended to convey any of: element A, element B, element C, elements A and B, elements A and C, elements B and C, and elements A, B, and C. It is to be understood that terminology employed herein is used for the purpose of describing particular examples only and is not intended to be limiting. It must be noted that, as used in this specification, the singular forms “a,” “an,” and “the” include plural referents unless the context clearly dictates otherwise. Further, one having skill in the art will understand the degree to which terms such as “about” or “substantially” convey in light of the measurement techniques utilized herein. To the extend such terms may not be clearly defined or understood by one having skill in the art, the terms such as “about” or “substantially” shall mean plus or minus ten percent.

The following numbered clauses define further example aspects and features of the present disclosure:
1. A spray device for dispensing fluid, the spray device comprising:
   a container including a container body configured to hold the fluid to be dispensed; and
   a sprayer assembly including:
   a housing coupled to the container;
   a nozzle assembly rotatably supported on the housing and having at least a first nozzle and a second nozzle, the first nozzle discrete and separated from the second nozzle on the nozzle assembly; and
   an actuator supported by the housing and coupled in fluid communication with the nozzle assembly, the actuator configured to selectively dispense fluid from the sprayer assembly via the nozzle assembly, wherein the nozzle assembly is rotatable between at least two spray configurations, a first spray configuration whereby the actuator dispenses fluid from the first nozzle and a second spray configuration whereby the actuator dispenses fluid from the second nozzle.
2. The spray device of clause 1, wherein the nozzle assembly is rotatable around a rotation axis, the first nozzle being oblique relative to the rotation axis.
3. The spray device of clause 2, wherein the second nozzle is oblique relative to the rotation axis.
4. The spray device of any one of the preceding clauses, wherein the second spray configuration is a 180° rotation from the first spray configuration.
5. The spray device of any one of the preceding clauses, wherein the first nozzle is oriented in an orthogonal direction relative to the second nozzle.
6. The spray device of any one of the preceding clauses, wherein the nozzle assembly comprises an extender, the second nozzle disposed on a distal end of the extender.
7. The spray device of any one of the preceding clauses, wherein the nozzle assembly is rotatable around a rotation axis, the nozzle assembly rotatable in both directions around the rotation axis.
8. The spray device of any one of the preceding clauses, wherein the nozzle assembly includes a stop indent for registering the nozzle assembly in both the first and second spray configurations.
9. The spray device of clause 8, wherein the stop indent provides an audible and/or a tactile register when the nozzle assembly is moved into the first and second spray configurations.
10. The spray device of any one of the preceding clauses, wherein the actuator includes a lock to prevent accidental fluid dispense.
11. The spray device of any one of the preceding clauses, wherein the housing is removably coupled to the container body.
12. The spray device of clause 11, wherein the housing is connected to the container body with a threaded connection, a rotating connection, a bayonet connection, or a press connection.
13. The spray device of any one of the preceding clauses, wherein the container body includes a fill level view strip.
14. The spray device of any one of the preceding clauses, wherein the actuator of the sprayer assembly is battery powered.
15. The spray device of any one of the preceding clauses, wherein the first nozzle and the second nozzle have different discharge configurations.
16. A method of manufacturing a spray device for dispensing fluid, the method comprising:
   forming a container having a container body configured to hold the fluid to be dispensed;
   assembling a sprayer assembly having a housing rotatably supporting a nozzle assembly and supporting an actuator, wherein the nozzle assembly has at least a first nozzle and a second nozzle, the first nozzle discrete and separated from the first nozzle on the nozzle assembly, and wherein the nozzle assembly is rotatable between at least two spray configurations; and
   coupling the sprayer assembly to the container, wherein the actuator is configured to selectively dispense fluid from the sprayer assembly via the nozzle assembly such that in a first spray configuration, the actuator dispenses fluid from the first nozzle, and in a second spray configuration, the actuator dispenses fluid from the second nozzle.
17. The method of clause 16, further comprising filling the container body with fluid.
18. The method of clause 17, wherein the fluid is one or more of a pesticide, a herbicide, or a fungicide.
19. The method of any one of clauses 16-18, wherein assembling the sprayer assembly comprises forming the nozzle assembly with the first nozzle oriented in an orthogonal direction relative to the second nozzle.
20. The method of any one of clauses 16-19, wherein coupling the sprayer assembly to the container comprises removably connecting the housing to the container body with a threaded connection, a rotating connection, a bayonet connection, or a press connection.
21. A spray device for dispensing fluid, the spray device comprising:
   a container including a container body configured to hold the fluid to be dispensed; and
   a sprayer assembly including:
   a nozzle assembly rotatably supported on the container around a rotation axis and having at least a first nozzle and a second nozzle, the first nozzle discrete and separated from the second nozzle on the nozzle assembly, wherein the first nozzle and the second nozzle are oblique relative to the rotation axis; and
   an actuator supported by the container body and coupled in fluid communication with the nozzle assembly, the actuator configured to selectively dispense fluid from the sprayer assembly via the nozzle assembly,
   wherein the nozzle assembly is rotatable between at least two spray configurations, a first spray configuration whereby the actuator dispenses fluid from the first nozzle and a second spray configuration whereby the actuator dispenses fluid from the second nozzle.
22. A spray device for dispensing fluid, the spray device comprising:
   a container including a container body configured to hold the fluid to be dispensed;
   a wand assembly including:
   a wand body having a reservoir configured to hold a charge of the fluid to be dispensed;
   a nozzle;
   an actuator configured to selectively dispense fluid from the wand assembly via the nozzle; and
   a hose connector releasably couplable to the wand body;
   a hose extending between the container body and the hose connector, and coupling the wand assembly in fluid communication to the container; and
   a mount releasably coupling the wand body to the container body,
   wherein when the wand body is engaged with the hose connector, the wand assembly is configured to dispense fluid while being connected to the container via the hose, and when the wand body is disengaged from the hose connector, the wand assembly is configured to dispense fluid from the reservoir while the wand body is disconnected from the container and completely remote therefrom.
23. The spray device of clause 22, wherein the actuator includes a lock to prevent accidental fluid dispense.
24. The spray device of any one of clauses 22-23, wherein the nozzle is mounted on an extender.
25. The spray device of any one of clauses 22-24, wherein the mount is coupled to the container body.
26. The spray device of any one of clauses 22-25, wherein the mount is integral with the container body.
27. The spray device of any one of clauses 22-26, further comprising a hose wrap configured to store at least a portion of the hose in a wrapped configuration.
28. The spray device of clause 27, wherein the hose wrap is interconnected with the mount.
29. The spray device of any one of clauses 22-28, wherein the wand body includes a window into the reservoir.
30. The spray device of any one of clauses 22-29, wherein the actuator of the wand assembly is battery powered.
31. The spray device of any one of clauses 22-30, wherein the wand body is detachable from the hose connector via a button.
32. The spray device of any one of clauses 22-31, wherein the reservoir has a smaller volume than the container body.
33. The spray device of any one of clauses 22-32, wherein when the wand body is engaged with the hose connector, the fluid dispensed from the wand assembly flows through the reservoir.
34. The spray device of any one of clauses 22-33, wherein after the wand assembly is used remote from the container, the wand assembly is configured to automatically refill the charge of fluid within the reservoir.
35. The spray device of any one of clauses 22-34, further comprising a cap having a dip tube for the container, the cap configured to receive the hose.
36. The spray device of any one of clauses 22-35, wherein the nozzle has two or more different discharge configurations.
37. A method of manufacturing a spray device for dispensing fluid, the method comprising:
   forming a container having a container body configured to hold the fluid to be dispensed;
   assembling a wand assembly that includes a wand body with a reservoir configured to hold a charge of the fluid to be dispensed, a nozzle, an actuator configured to selectively dispense fluid from the wand assembly via the nozzle, and a hose connector that releasably couples to the wand body;
   providing a hose that couples the wand assembly to the container in fluid communication;
   forming a mount; and
   releasably coupling the wand body to the container body via the mount, and wherein when the wand body is engaged with the hose connector, the wand assembly is configured to dispense fluid while being connected to the container via the hose, and when the wand body is disengaged from the hose connector, the wand assembly is configured to dispense fluid from the reservoir while the wand body is disconnected from the container and completely remote therefrom.
38. The method of clause 37, further comprising filling the container body with fluid.
39. The method of clause 37, wherein the fluid is one or more of a pesticide, a herbicide, and a fungicide.
40. The method of any one of clauses 37-39, further comprising wrapping at least a portion of the hose around a hose wrap.
41. The method of any one of clauses 37-40, wherein the wand body is formed with a battery chamber such that the wand assembly is battery powered.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the above clauses and below claims and any equivalents therein.

1. A spray device for dispensing fluid, the spray device comprising:
a container including a container body configured to hold the fluid to be dispensed; and
a sprayer assembly including:
a housing coupled to the container;
a nozzle assembly rotatably supported on the housing and having at least a first nozzle and a second nozzle, the first nozzle discrete and separated from the second nozzle on the nozzle assembly; and
an actuator supported by the housing and coupled in fluid communication with the nozzle assembly, the actuator configured to selectively dispense fluid from the sprayer assembly via the nozzle assembly,
wherein the nozzle assembly is rotatable between at least two spray configurations, a first spray configuration whereby the actuator dispenses fluid from the first nozzle and a second spray configuration whereby the actuator dispenses fluid from the second nozzle.

2. The spray device of claim 1, wherein the nozzle assembly is rotatable around a rotation axis, the first nozzle being oblique relative to the rotation axis.

3. The spray device of claim 2, wherein the second nozzle is oblique relative to the rotation axis.

4. The spray device of claim 1, wherein the second spray configuration is a 180° rotation from the first spray configuration.

5. The spray device of claim 1, wherein the first nozzle is oriented in an orthogonal direction relative to the second nozzle.

6. The spray device of claim 1, wherein the nozzle assembly comprises an extender, the second nozzle disposed on a distal end of the extender.

7. The spray device of claim 1, wherein the nozzle assembly is rotatable around a rotation axis, the nozzle assembly rotatable in both directions around the rotation axis.

8. The spray device of claim 1, wherein the nozzle assembly includes a stop indent for registering the nozzle assembly in both the first and second spray configurations.

9. The spray device of claim 8, wherein the stop indent provides an audible and/or a tactile register when the nozzle assembly is moved into the first and second spray configurations.

10. The spray device of claim 1, wherein the actuator includes a lock to prevent accidental fluid dispense.

11. The spray device of claim 1, wherein the housing is removably coupled to the container body.

12. The spray device of claim 11, wherein the housing is connected to the container body with a threaded connection, a rotating connection, a bayonet connection, or a press connection.

13. The spray device of claim 1, wherein the container body includes a fill level view strip.

14. The spray device of claim 1, wherein the actuator of the sprayer assembly is battery powered.

15. The spray device of claim 1, wherein the first nozzle and the second nozzle have different discharge configurations.

16. A method of manufacturing a spray device for dispensing fluid, the method comprising:
forming a container having a container body configured to hold the fluid to be dispensed;
assembling a sprayer assembly having a housing rotatably supporting a nozzle assembly and supporting an actuator, wherein the nozzle assembly has at least a first nozzle and a second nozzle, the first nozzle discrete and separated from the first nozzle on the nozzle assembly, and wherein the nozzle assembly is rotatable between at least two spray configurations; and
coupling the sprayer assembly to the container, wherein the actuator is configured to selectively dispense fluid from the sprayer assembly via the nozzle assembly such that in a first spray configuration, the actuator dispenses fluid from the first nozzle, and in a second spray configuration, the actuator dispenses fluid from the second nozzle.

17. The method of claim 16, further comprising filling the container body with fluid.

18. The method of claim 17, wherein the fluid is one or more of a pesticide, a herbicide, or a fungicide.

19. The method of claim 16, wherein assembling the sprayer assembly comprises forming the nozzle assembly with the first nozzle oriented in an orthogonal direction relative to the second nozzle.

20. The method of claim 16, wherein coupling the sprayer assembly to the container comprises removably connecting the housing to the container body with a threaded connection, a rotating connection, a bayonet connection, or a press connection.
